(19) United States
(12) Patent Application Publication
(10) Pub. No.: US 2006/0230410 A1
(43) Pub. Date: Oct. 12, 2006

(54) Methods and systems for developing and testing speech applications

(76) Inventors: Alex Kurganov, Buffalo Grove, IL (US); Mike Shirobokov, Chicago, IL (US); Sean Garratt, Schaumburg, IL (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/387,151

(22) Filed: Mar. 22, 2006

Related U.S. Application Data
(60) Provisional application No. 60/664,025, filed on Mar. 22, 2005.
(60) Provisional application No. 60/697,178, filed on Jul. 7, 2005.
(60) Provisional application No. 60/703,596, filed on Jul. 29, 2005.

(51) Int. Cl. G06F 9/46

(52) U.S. Cl. 719/311

(57) ABSTRACT

A system and method for facilitating the efficient development, testing and implementation of speech applications is disclosed which separates the speech user interface from the business logic. A speech user interface description is created devoid of business logic in the form of a machine readable markup language directly executable by the runtime environment based on business requirements. At least one business logic component is created separately for the speech user interface, the at least one business logic component being accessible by the runtime environment.

The present application claims the benefit of priority to U.S. Provisional Patent Application No. 60/664,025 filed Mar. 22, 2005, U.S. Provisional Patent Application No. 60/697,178 filed Jul. 7, 2005, and U.S. Provisional Patent Application No. 60/703,596 filed Jul. 29, 2005, all of which are hereby incorporated by reference in their entirety.

### BACKGROUND OF THE INVENTION

A conventional process for developing a speech user interface (“SUI”) includes three basic steps. First, a SUI designer creates a human readable specification describing the desired SUI using drawings, flowcharts, writings, or other human-readable formats. Second, the SUI designer gives the specification to a code developer, who programs the application using an existing markup language, usually Voice eXtensible Markup Language (“VoiceXML” or “VXML”) or Speech Application Language Tags (“SALT”). The code developer simultaneously incorporates business logic that retrieves information from an outside database and brings it into the markup language file. Third, the coded application is tested by quality assurance (“QA”) to screen for errors. When QA finds errors, it reports back to the code developer, who either debugs the code and returns it to QA for further analysis, or, if the error lies within the SUI design, gives the specification back to the SUI designer for revision. The SUI designer then revises the specification and returns it to the code developer, who re-implements the SUI code simultaneously with the business logic and again returns the coded application to QA for further analysis. This process is repeated until QA determines that the product is suitable for final release.

Thus, in many commercial frameworks that use existing markup languages like VXML or SALT, SUI logic is mixed with business logic in speech applications. Mixing SUI logic with business logic increases the chances of bugs in speech applications, which may diminish the quality of the speech applications through inconsistent speech user interface behavior and lengthened development, QA and release cycles.

One problem with this approach is that it leads to inefficient development. After the code developer implements the application, the design goals produced by the designer and the final implemented SUI are rarely the same thing. To illustrate why this happens, consider the following: when humans play the game of telephone, one person speaks a message to another, who repeats the message to a third, and so on, until the message is invariably altered due to the imperfection of human verbal interaction. Such is also the case in the above described software development cycle. The SUI designer, ideally a non-programmer who specializes in human interactions, has one idea for the project which he or she communicates to development in the form of human-readable text, flowcharts, figures or other methods. The code developer attempts to implement precisely the designer's ideal from the technical perspective of a programmer, who must simultaneously implement the required business logic underlying the application. Thus, the code developer's output is inevitably altered from the idea of the designer.

Another problem with the existing approach is that the mixture of business logic and SUI logic makes transparent SUI design impossible. In existing commercial frameworks, the SUI designer's SUI often takes the form of either: (1) a rough prototype for the SUI consisting of human-readable text, flowcharts, or other types of diagrams, such as those created with software such as Visio® by Microsoft Corporation, which a developer must then implement; or (2) an exact design for which code is automatically generated. The first approach creates the telephone-game problems of inefficient development outlined above. The second approach inevitably includes business logic, which means the SUI designer must have some idea of how the underlying business logic will work, making the SUI non-transparent for a non-programmer.

Yet another inefficiency arises if either the SUI design goals change or if QA finds an error in the SUI design at any time during the life cycle of the speech application. Either scenario requires that the code developers pass control of the project back to the designer for SUI revision. Once the designer corrects the error, he or she must return the revised SUI design to the code developer, who must once again re-implement it along with the business logic, which may have not even had errors by itself. Thus, in the prior art, if there is an error, regardless of whether it is found in business logic or SUI logic, the code developer must debug the entire application, not just the SUI or the business logic, in order to find and eliminate the bug. This repeated implementation and integration of the business logic with the SUI logic drives up labor and development costs and lengthens development and release cycles.

Still another problem with the traditional three-step development process is that it leads to inefficient testing. It is virtually impossible to machine-read existing markup languages like VXML or SALT and derive any knowledge about the SUI, because it is mingled with business logic which cannot be easily parsed out. In most applications, the markup language is not static but rather is generated on the fly as the application is running. This makes it virtually impossible to automate SUI testing in all the existing markup languages. QA testing of the final release thus involves simultaneous testing of business and SUI logic, a process incapable of automation. This means that more labor is required to perform comprehensive quality assurance, which increases the cost of QA labor and again lengthens the overall release cycle.

Accordingly, there is a need for an improved method of SUI design, testing and deployment which is built around a fundamental separation of the logic behind the SUI and any other business logic.

### SUMMARY OF THE INVENTION

In accordance with one aspect of the present invention, a method for developing a speech application is provided. The first step of the method is creating a speech user interface description devoid of business logic in the form of a machine readable markup language directly executable by a runtime environment based on business requirements. The second step of the method is creating separately at least one business logic component for the speech user interface, the at least one business logic component being accessible by the runtime environment.

In accordance with another aspect of the present invention, a system for developing a speech application is provided. The system includes a runtime environment and a speech user interface description devoid of business logic in the form of a machine readable markup language directly executable by the runtime environment based on business requirements. The system further includes at least one business logic component for the speech user interface, the at least one business logic component being accessible by the runtime environment.

### BRIEF DESCRIPTION OF THE DRAWINGS

FIG. 1 is a diagram of the speech user interface design cycle in accordance with an embodiment of the present invention;

FIG. 2 shows an example of a speech user interface development toolkit in accordance with another embodiment of the present invention;

FIG. 3 is a diagram of the one-way communication from the speech user interface designer to the code developers in accordance with an embodiment of the present invention;

FIG. 4 is a diagram illustrating the steps of testing in accordance with an embodiment of the present invention;

FIG. 5 is a diagram illustrating the steps of automated testing in accordance with another embodiment of the present invention;

FIG. 6 is a diagram illustrating the architecture of an embodiment of the present invention;

FIG. 7 is a diagram illustrating an aspect of web speech markup language in accordance with an embodiment of the present invention; and

FIG. 8 is a diagram illustrating another aspect of web speech markup language in accordance with another embodiment of the present invention.

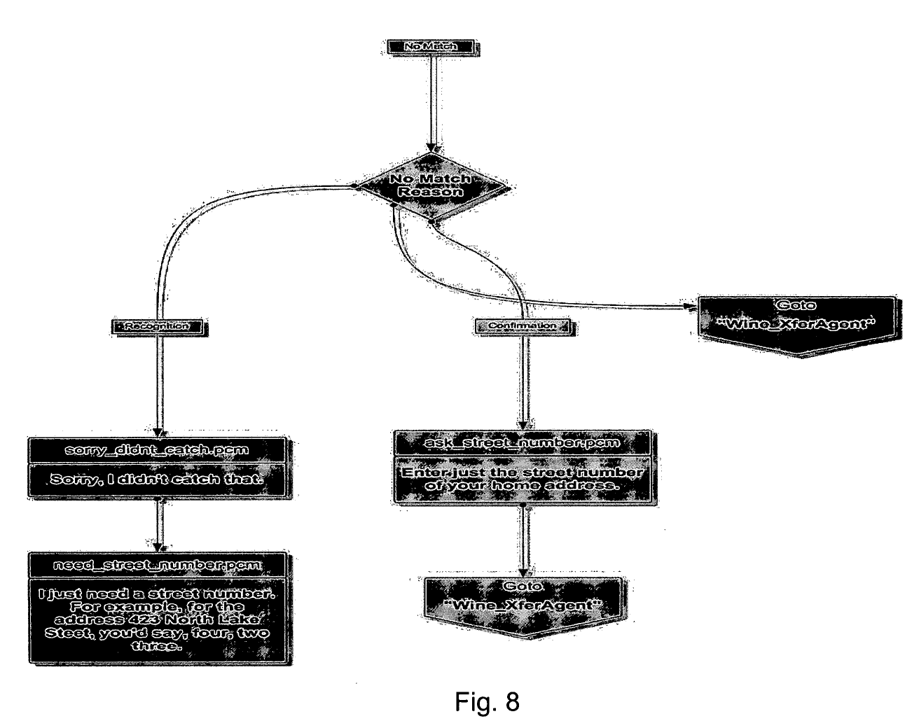

### DETAILED DESCRIPTION OF THE INVENTION

The present invention separates SUI logic from business logic by utilizing a markup language and markup language interpreter combination that, aside from a few exceptions, completely controls the SUI logic. SUI logic is defined in the present invention as any logic directing the interaction between the caller and the interactive voice response (“IVR”) system, subject to possible limited business logic overrides. It includes dialogs, grammars, prompts, retries, confirmations, transitions, overrides, and any other logical tool directing the human-machine interaction. Business logic is defined as any logic outside the realm of SUI logic. It includes data pre-processing actions (e.g., checking the validity of the phone number entered), the actual database query formation and data retrieval, any possible post-processing of the data returned, and any other logic not directing the human-machine interaction. Markup language should be understood to mean any machine-readable language that abstracts the presentation or layout of the document; in other words, a markup language will separate the structure and appearance of a file as experienced by a user from its content.

The present invention utilizes a markup language that abstracts out or automates all of these different actions. The result is a separation of SUI logic from business logic. The markup language interpreter is capable of fully controlling the SUI, aside from possible overrides from the business logic. The interpreter sends requests for data or user commands to the business logic, and the business logic returns either the requested data, or error messages giving one of a plurality of reasons for the failure. The user commands may be given in the form of speech commands, DTMF or touch-tone commands, touchpad or mouse commands, keyboard or keypad commands, or through drag-and-drop commands of a graphical user interface (“GUI”). The interpreter similarly interacts with speech recognition (or DTMF recognition) engines by sending user inputs, and the interpreter receives in return values indicating either a match, no match, or no response.

By making this fundamental separation, the present invention seeks to accomplish the following objectives: (1) solve the “telephone” problem inherent in traditional IVR application design; (2) make SUI transparent for a non-programmer; (3) provide for separate debugging and revision of SUI logic and business logic, which allows each respective team to solely focus on their areas of expertise; and (4) allow for automated testing of the SUI logic.

The first objective of the invention is to eliminate the “telephone” problem by allowing the SUI designer complete control of the SUI, from start to finish. The SUI's output does not need to be coded but rather is ready to execute, eliminating the inevitable confusion created in the prior art where the SUI design was implemented by code developers. This means that the code developers will not be required to implement the SUI designer's idea of the SUI, an area in which the code developers are not likely trained.

The second objective of the present invention is to make the SUI transparent to a non-programmer. The markup language used in the present invention makes it possible for the SUI designer to create the SUI without any knowledge of programming or the underlying business logic whatsoever. It allows the designer to include simple placeholders which should be “filled” with caller-requested information, instead of requiring the designer to include server-side scripts or other types of business logic.

Because of the static nature of the present invention's markup language, design of such interfaces using a toolkit is simple and intuitive. In one embodiment of the invention, this toolkit is an application consisting of a GUI and underlying logic, which allows non-technically trained personnel to drag and drop various dialog elements into a what-you-see-is-what-you-hear environment. The designer will be able to specify placeholders, transitions, prompts, overrides and possible commands available with each dialog. When the designer saves his or her work, the output is in the form of a markup language that, unlike VXML or other similar voice markup languages, is a self-contained static flowchart description. The preferred output format is in Web Speech Dialog Markup Language (“WSDML”), an XML-based language developed by Parus Interactive and owned by Parus Holdings, Inc.

Although the prior art contains numerous similar-appearing development toolkits, e.g., U.S. Pat. No. 5,913,195 to Weeren et al., the disclosed toolkit is the only development toolkit capable of producing markup language describing a completely autonomous SUI independent from any business logic. The toolkits contained in the prior art similarly implement intuitive GUIs, but they require programming knowledge on the part of the designer because he or she must indicate exactly how the SUI will interact with the business logic. These are complex tools, which require a trained programmer to use. The present invention avoids this problem by eliminating any requirement of business logic knowledge on the part of the SUI designer. Thus, it is possible for a non-technical person to create and revise SUIs. Conversely, code developers (i.e., business logic programmers) are able to focus almost exclusively on business logic development and are not required to have any knowledge of SUI design.

The third objective of the invention is to improve the development process by way of separation of business logic error correction and SUI logic error correction. Whatever the designer creates will be machine-readable, which means that it can immediately be tested and/or run by a machine, eliminating the delay of waiting for the code developers to implement the SUI, as required by the prior art. Further, if an error is detected in the SUI design, or if QA simply decides that there is a better way to design the interface, feedback goes straight to the designer, who can immediately fix any problems and resubmit the SUI. This separate development of the SUI will not interfere with the code developers, who only need to know the position of placeholders within the SUI design. Likewise, if QA finds a business logic error, QA only needs to tell the code developers, who will fix any problems without touching the SUI.

The fourth objective of the present invention is to automate testing. QA personnel have the ability to completely automate testing of the SUI. Once they create the test cases (or the test cases are defined for them), QA personnel only need to initiate the automated testing, and then they are free to test other aspects of the project, such as the business logic. QA also benefits in that they only need to communicate SUI problems to the SUI designer, and business logic problems to the code developers.

### DETAILED DESCRIPTION OF THE PREFERRED EMBODIMENT

The present invention will now be described more fully with reference to the Figures in which the preferred embodiment of the present invention is shown. The subject matter of this disclosure may, however, be embodied in many different forms and should not be construed as being limited to the embodiment set forth herein.

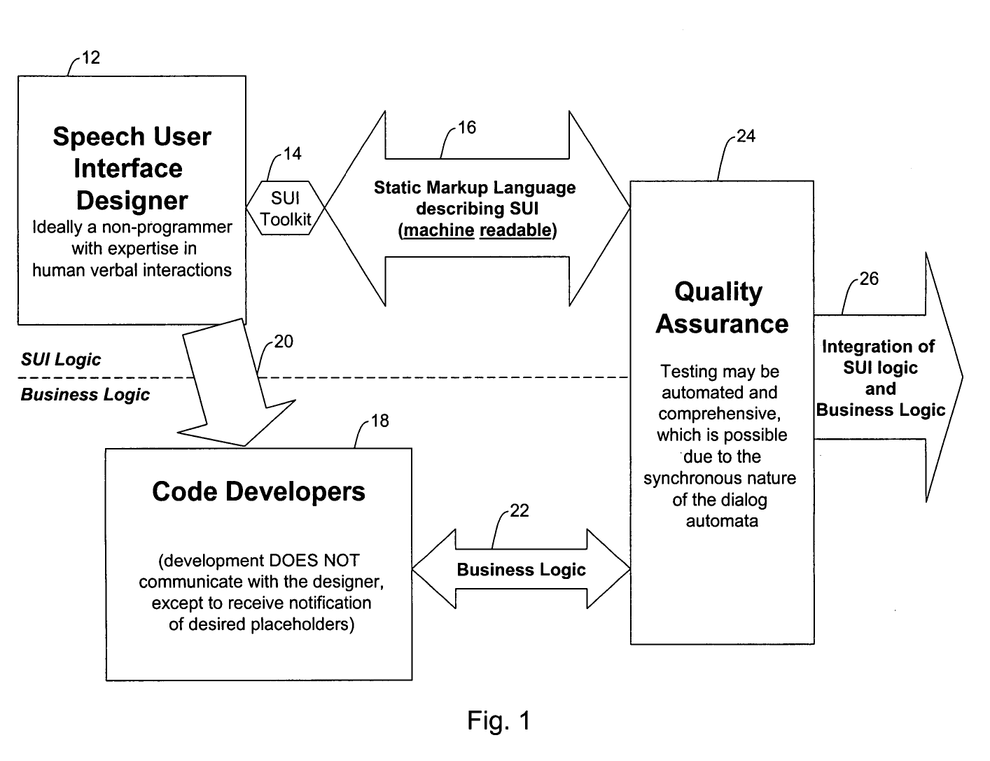

Referring now to the drawings, wherein like reference numerals designate identical or corresponding parts throughout the several views, FIG. 1 illustrates how voice applications are developed in accordance with the present invention. A speech user interface designer (“SUID”) 12 uses the claimed speech application development toolkit 14 to build a SUI described in a static machine-readable markup language 16. The only communication between the SUID 12 and the code developers 18 is via placeholders 20 that the SUID 12 inserts into the markup language 16 via the toolkit 14. These placeholders 20 represent a piece of information requested by the user (e.g., account balance or credit limit). The SUID 12 merely holds a place for the information, and the code developers 18 implement any business logic 22 required to return the requested value(s) or execute any requested commands.

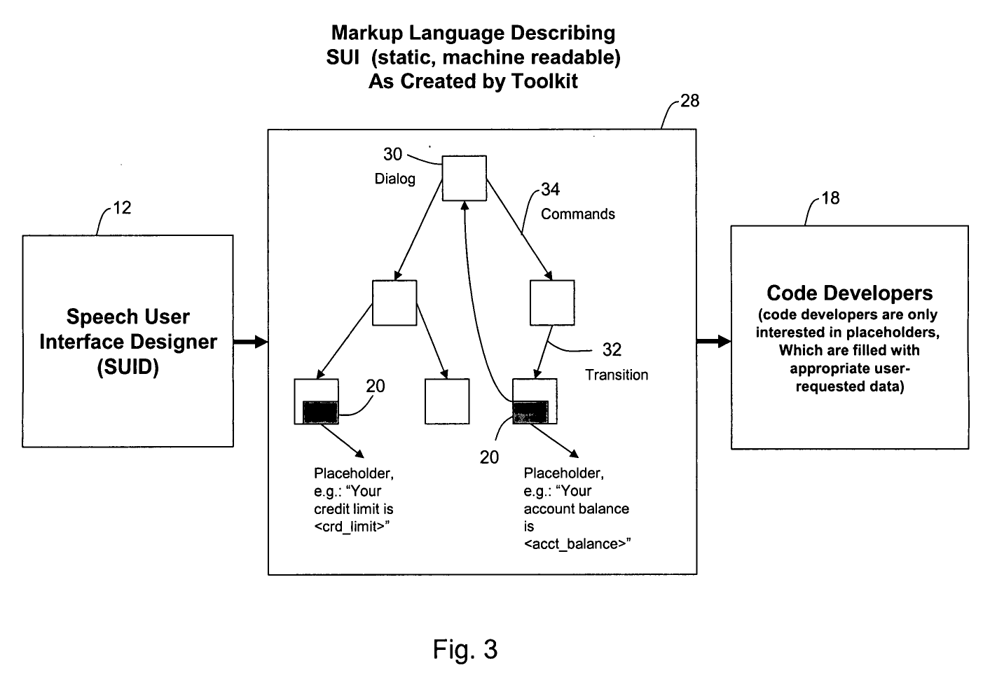

On the business logic side, the code developers 18 receive the same markup language code 20 containing the placeholders and possible user commands. The job of the code developers 18 is to return the appropriate values for the placeholders. This one-way communication from the SUID 12 to the code developers 18 is illustrated further in FIG. 3. This allows for completely modular development; the code developers 18 need only build the discreet functions to accomplish any required tasks (e.g., retrieving account balances or credit limits). They need not (and indeed should not) be involved in any way with the design of the user interface.

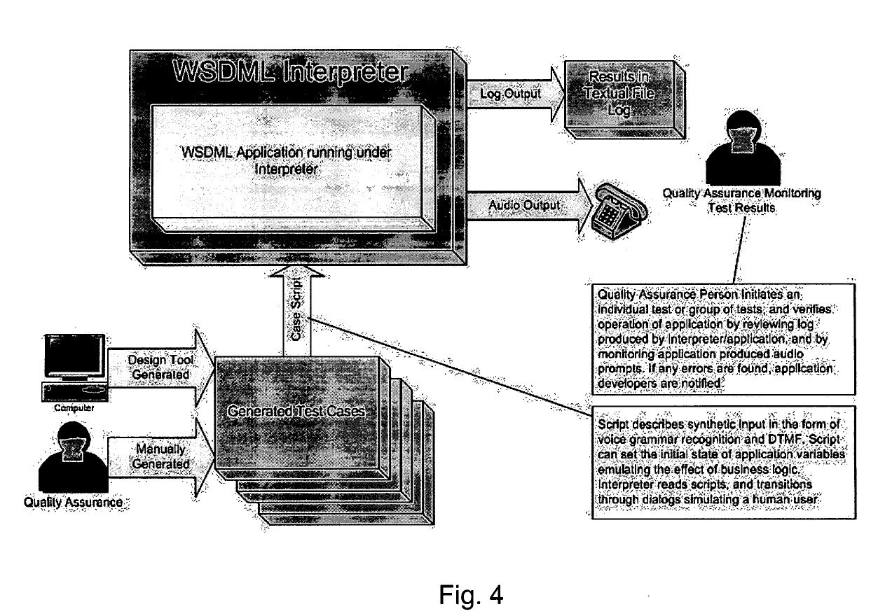

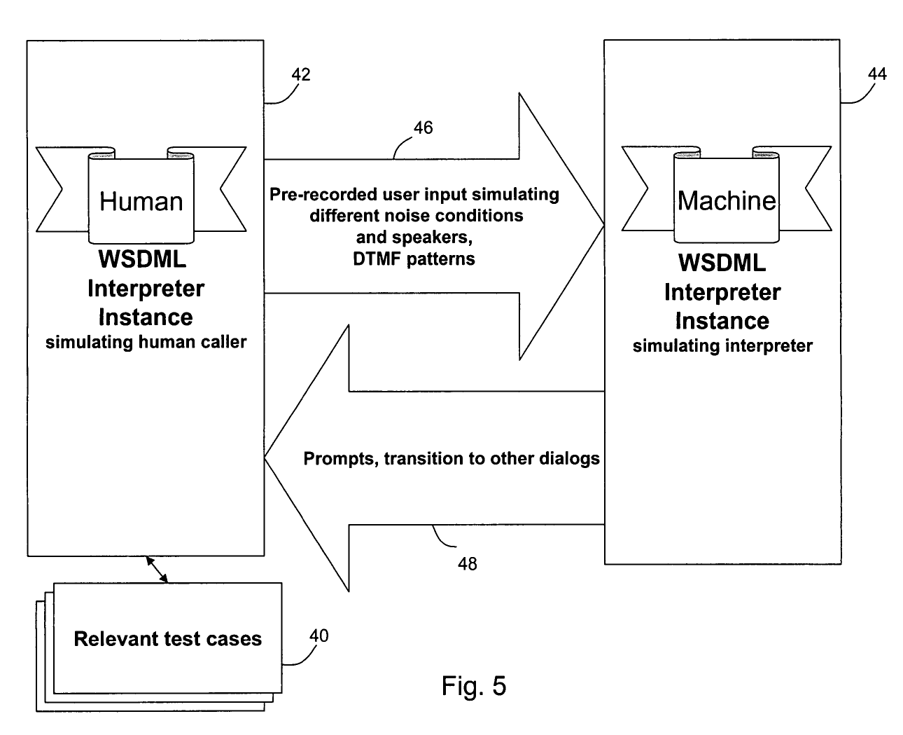

Once the SUID 12 and the code developers 18 complete their respective pieces of the final product, they give their work to quality assurance (QA) 24 for testing and debugging. The SUI toolkit 14 outputs machine-readable markup language 16, such as WSDML as shown in FIG. 1, for which QA 24 is able to set testing, as demonstrated in FIGS. 4 and 5. QA 24 separately tests the business logic 22, which is made easier because the business logic is not intermingled with the SUI logic 16. Separate feedback is given to the SUID 12 regarding only the interface design, and to the code developers 18 regarding only business logic 22. This way, if there is only a problem with the business logic 22, and the SUI logic 16 is sound, then the SUID 12 need not be involved in the subsequent revision of the project. Conversely, if there is only a problem with the SUI logic 16, and the business logic 22 is sound, then the code developers 18 need not get involved in the subsequent revision (except to the extent that it must recognize any new placeholders). After the SUI logic 16 and business logic 22 have been checked by QA 24, the various codes may be integrated or made available to one another on a runtime environment, as indicated by reference numeral 26. It is also possible for the quality assurance process to be performed after the SUI logic 16 and business logic 22 have been integrated. Typically, the quality assurance process occurs independently on both the SUI side and the business programming side before both the SUI logic 16 and business logic 22 are submitted to QA 24 for final testing.

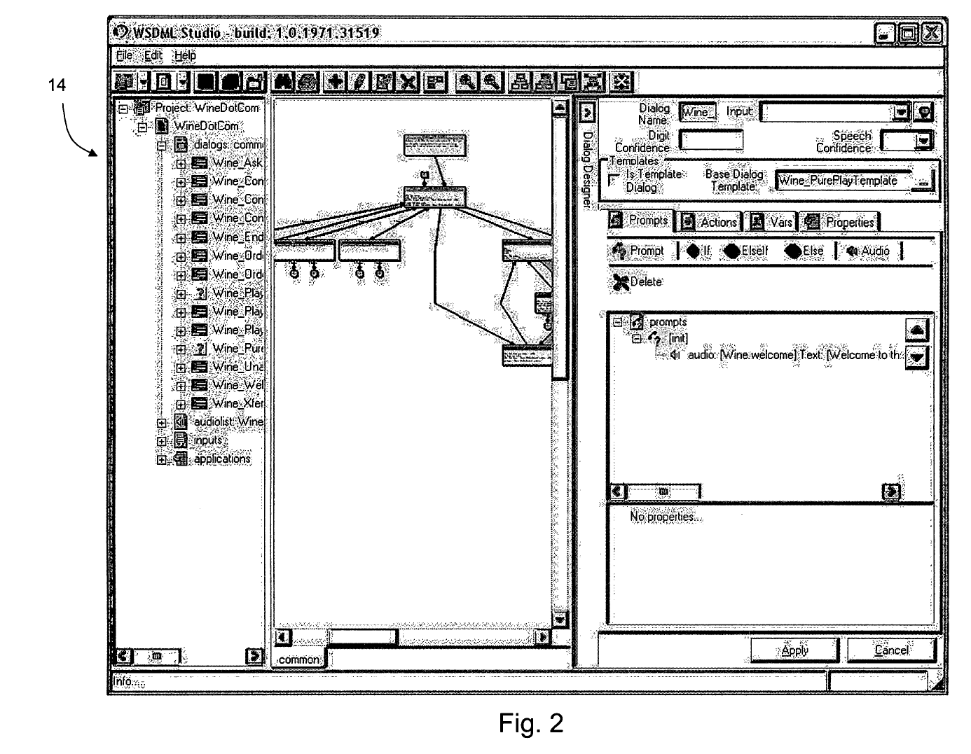

FIG. 2 shows an example of the SUI development toolkit 14, in accordance with an embodiment of the present invention. As further explained in FIG. 3, the SUI development toolkit allows the SUID 12 to drag-and-drop various dialogs, which may be customized depending on the specific speech application. The SUID 12 arranges the dialogs as desired to create a SUI description and then connects the dialogs using arrows to indicate the intended call flow. The toolkit 14 automatically creates the SUI logic 16, which is a static, machine readable markup language describing the SUI description. The SUI logic 16 is static in that the markup language is not generated on-the-fly like VXML or other conventional protocols. Additionally, the SUI logic 16 is machine readable by a runtime environment, unlike outputs generated by programs such as Visio®.

FIG. 3 illustrates the only communication between the SUID 12 and the code developers 18, which is a one-way communication between the SUID and the code developers. In order for the present invention to make the design of IVRs more efficient, it is absolutely necessary to allow the SUID 12 to design the SUI without detailed knowledge of the parallel business logic. Indeed the SUID 12 should be a non-programmer, ideally someone with expertise in human interactions and communications. The SUID 12 gives the code developers 18 a copy of the markup language file describing the SUI. The SUI description 28 includes dialogs 30 and transitions 32 to establish the call flow. The SUID 12 leaves placeholders 20 where business logic or user commands 34 need to be added by the code developers. The code developers 18 only need to find the placeholders 20 and user commands 34 which explain to the code developers the business functionality to be implemented.

This is one place where the present invention diverges greatly from the prior art. While any markup language that entirely separates the business logic from the SUI logic as described thus far would suffice, the preferred embodiment utilizes Web Speech Dialog Markup Language (“WSDML”), an XML-based language developed by Parus Interactive and owned by Parus Holdings, Inc. WSDML introduces elaborate dialog automation and dialog inheritance at the WSDML interpreter level. One of the main differences between WSDML and VXML (or any other existing speech markup languages, such as SALT) is that WSDML describes both individual dialogs and transitions between them. For instance, VXML does not provide for robust dialog transitions beyond simple form filling.

VXML was developed as a very web-centric markup language. In that way VXML is very similar to the Hyper Text Markup Language (“HTML”) in that HTML applications consist of several individual web pages, each page analogous to a single VXML dialog. To illustrate this difference, VXML will first be analogized to HTML, and then WSDML will be contrasted to both VXML and HTML.

In a typical HTML/web-based scenario, if a user wanted to log onto a bank's website, the user first is presented with a simple page requesting a bank account number, which provides a field or space for the user to input that information. After entering the account number, the user's input is submitted to the web server. With this information, the web server executes a common gateway interface (“CGI”) program, which uses the user input to determine what information, typically in the form of a user interface coupled with the desired information, should be presented to the user next. For instance, if the user gives an invalid account number, the CGI program will discover the error when it references the input to the bank's database. At this point, based on a negative response from the bank's database, the CGI program produces output which, through the web server, presents the user with a webpage, such as a page displaying the message “Invalid Account Number. Please try again.”

VXML operates in a similar fashion. The same user, this time using a telephone to access the bank's automated system, is presented with an audio prompt asking, “Please enter or speak your account number.” After speaking or inputting via DTML the account information, the VXML browser interacts with separate speech (or DTML) recognition software to determine whether the input satisfies the present grammar, or a finite set of speech patterns expected from the user. Then, the VXML browser sends this input to the VXML server or a web server capable of serving VXML pages. The VXML server tests the input against the bank's remote database using CGI and determines what information, in the form of a user interface coupled with the desired information, should be presented to the user next. For instance, if the user gives an invalid account number this time, the CGI program again receives a negative response from the bank's database. The CGI program then sends a VXML page to the web server, which transmits this page to the VXML browser and, in turn, prompts the user with an audio response, such as: “The account number was invalid. Please try again.”

WSDML operates differently. The SUI is static; it does not depend on the information returned from the CGI. Instead, the SUI is automated at the WSDML interpreter (or WSDML browser) level. The WSDML interpreter does not need to run any CGI scripts (or have an adjunct script interpreter run subscripts) to determine what to do next, as the typical CGI setup does. In that sense, the WSDML file serves as a comprehensive static flowchart of the conversation.

To illustrate, the same user once again calls a bank to access an automated telephone system, which this time utilizes a WSDML-based IVR system. The system may prompt the caller with an audio message, such as: “Please enter or speak your account number.” The caller speaks (or dials) his account number, which is processed by a separate speech (or DTMF) recognition engine against a grammar. Provided the spoken input satisfies the grammar, the WSDML interpreter makes a simple request to the business logic containing the account number instead of running a CGI program with the account number as input. And, instead of a CGI program determining whether the account number matches the bank's database or what the caller will be presented with next, the business logic simply returns values to the WSDML interpreter indicating whether the command was valid and, if so, the requested information. Based on this return value, the WSDML interpreter decides what to present to the user next. Using the same example, if the account number given to the business logic is invalid despite satisfying the grammar, the business logic returns an error indicating that the input was invalid, and a separate reason for the error. The WSDML outcome, which up to this point has been “MATCH” as a result of the satisfaction of the grammar, is converted to “NOMATCH,” and the WSDML interpreter continues to another dialog depending on the reason for the invalidity.

Additionally, in an embodiment of the present invention, the markup language allows for dialog inheritance or templates, meaning that the user may create top level dialogs that operate similarly to high-level objects in object-oriented programming. Lower level objects inherit common properties from the top level objects. In this way the top level dialogs operate as “templates” for the lower dialogs, allowing for global actions, variables, and other dialog properties.

FIG. 4 shows one embodiment of the quality assurance testing which is conducted by quality assurance (QA). QA generates test case scripts either manually by editing textual files using a documented test case script syntax, or with computer assistance using features incorporated within the design tool to simplify the creation of test cases. Test cases are developed with an expected outcome known given a consistent input, which is determined by reviewing the design documentation of the application. Test case script files are permanently stored so that they may be run multiple times during the course of the QA process. Upon submitting the test case script to the interpreter, the interpreter will act upon the script as if it were receiving input from a human user in the form of voice commands and telephone DTMF keypad presses. In addition, test case scripts can initialize the condition of data and variables in the application's business logic to synthesize real life conditions, or set up initial conditions. During or at the conclusion or the test case execution, QA personnel can verify that the output of the application is consistent with the documented intention of the application's design, and if not, report error conditions back to application developers for correction.

In another embodiment of the invention, SUI testing is automated as shown in FIG. 5. As part of the WSDML describing a SUI, a plurality of test cases 40 are defined. Each test case 40 includes the following information: (1) a list of dialogs covered by that test case; and (2) within each such dialog of a given test case, the following elements are defined: (i) audio commands understood and described in the given dialog simulating different speakers and noise conditions; and (ii) runtime variables with their values enabling simulation of a given set of SUI scenarios or behaviors that the given test case 40 is intended to test. There are two different interpreter scenarios: the first scenario 42 simulates a human caller; and the second scenario 44 simulates a machine. Each interpreter scenario in a test session starts with a flag indicating the role (human or machine), and both scenarios use the same WSDML content access reference and specific test cases 40 as parameters. Thus, the “human” interpreter reads relevant test case information and calls the “machine” interpreter to issue specified commands (at random), as indicated by reference numeral 46. Upon hearing audio commands from a “human” interpreter, the machine interpreter, while continuing to other dialogs, assumes the corresponding runtime variables from the same test case descriptor and sends responses to the “human” interpreter, as indicated by reference numeral 48. By focusing on a certain set of SUI scenarios described in specific test cases, it is possible to organize efficient automated testing of speech user interfaces in terms of speech parameters for noise, speed versus accuracy, valid grammars, n-best handling, valid time-outs, valid dialog construction, accurate understanding of various non-native speakers, valid DTMF commands, and valid response delays.

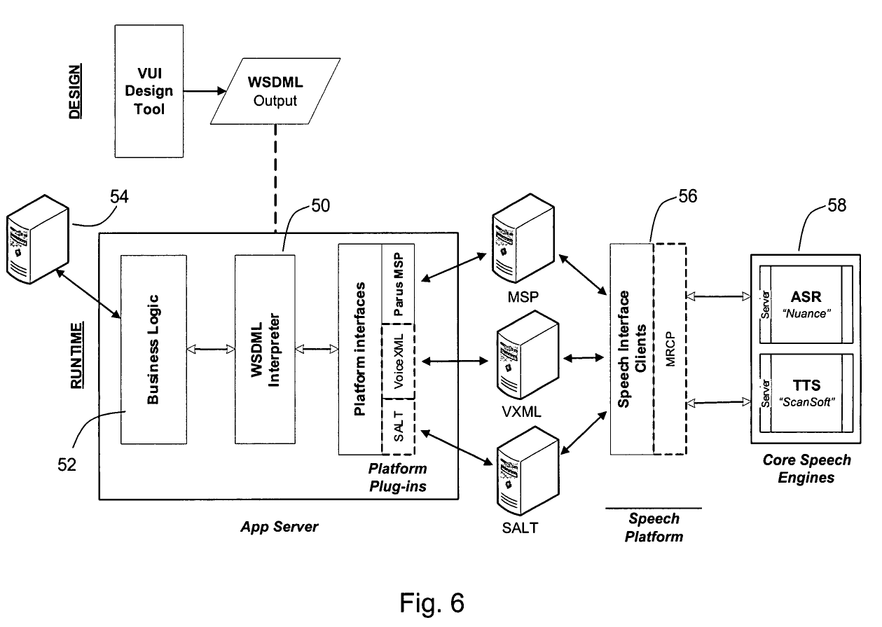

In another embodiment of the present invention as shown in FIG. 6, the WSDML interpreter 50 interacts with the business logic and speech platforms over a local area network (“LAN”) or wide area network (“WAN”), such as a private internet or the public Internet. Upon coming across a placeholder or user command, the interpreter 50 communicates with a dedicated business logic server 52 (on the same LAN or on a WAN). The business logic server 52, which can be local or remote to the interpreter 50, retrieves the desired caller data from a database 54, executes the desired caller command, and completes any other requested action before sending a response back to the interpreter 50. When the interpreter 50 receives voice input, it similarly sends that to a remote speech recognition server or platform 56 for processing by one or more speech recognition engines 58.

In yet another embodiment of the present invention, the interpreter consists of a computer program server that takes as input WSDML files and, using that information, conducts “conversations” with the caller. The interpreter may obtain the WSDML files from a local storage medium, such as a local hard drive. The interpreter also may obtain the WSDML files from a remote application server, such as a web server capable of serving XML-style pages.

In still another embodiment of the present invention, the interpreter has built-in individual business logic functions for each possible user request. For example, the code developers program “black box” functions that simply take as input the user's account number, and return the information the user requests, such as the user's account balance or the user's credit limit. These functions reside in entirely separate locations from the interpreter code that interprets and serves WSDML dialog to the user.

In still yet another embodiment of the present invention, the interpreter is implemented as a library for an application. In this scenario, the application provides the WSDML server with “hooks,” or callback functions, which allow the interpreter to call the given business logic function when necessary. The application server similarly provides “hooks” for when the caller instigates an event, such as a user command.

WSDML Dialog Concept:

WSDML is, to at least some extent, an expression of the WSDML Dialog concept. WSDML Dialog (“dialog”) describes a certain set of interactions between the caller and the voice application over the telephone. A dialog ends when one of defined outcomes is detected based on the caller's input; at that point it is ready to proceed to the next dialog. A dialog may pass a certain number of intermediate states based on a preset counter, before it arrives to an acceptable outcome. The main dialog outcomes explicitly defined in WSDML are: “No Input,” “No Match,” and “Match.” Dialog error outcomes caused by various system failures are handled by the corresponding event handlers, and any related error announcements may or may not be explicitly defined in WSDML. A single dialog interaction normally is accomplished by a single Play-Listen act when the application plays a prompt and listens to the caller's input. This general case of interaction also covers various specific interaction cases: play-then-listen (with no barge-in), pure play, and pure listen. The notion of “listen” relates to both speech and touch-tone modes of interaction.

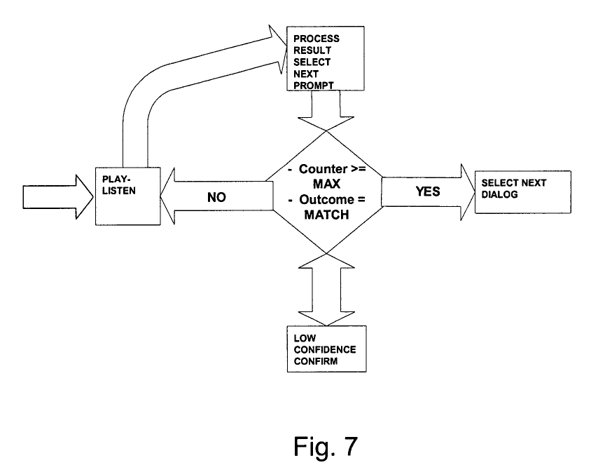

Following are the steps of the dialog process, which are shown in FIGS. 6 and 7:

(a) A dialog starts with the initial prompt presented to the caller.

(b) The caller's input is collected and the result is processed.

(c) The outcome is determined and the next prompt is set accordingly.

(d) Depending on the outcome and the preset maximum number of iterations, the next caller interaction (perhaps playing a different prompt) within the same dialog is initiated, or control is passed to the next dialog.

(e) The dialog may include a confirmation interaction. In this case, if low confidence is returned as part of the interaction result, then the outcome is determined by the result of the confirmation dialog. Irrespective of the confirmation result and the subsequent outcome, control is always passed to the next dialog after the confirmation.

Table 1 below describes possible dialog outcomes:

| Dialog | |
|---|---|
| Outcome | Description |
| MATCH | This outcome occurs when the result of the caller |
| | interaction matches one of the expected values, such as a |
| | sequence of digits or a spoken utterance described in the |
| | grammar. Also, this outcome occurs when the caller |
| | confirms a low confidence result as valid within the |
| | confirmation sub-dialog. |
| NO MATCH | This outcome occurs when the result of the caller |
| | interaction does not match one of the expected values, such |
| | as a sequence of digits or a spoken utterance described in |
| | the grammar. Also, this outcome occurs when the caller |
| | does not confirm a low confidence result as valid within the |
| | confirmation sub-dialog. |
| NO INPUT | This outcome occurs when no input is received from |
| | the caller while some input is expected. |
| ALL* | This outcome is used in cases where the action is the |
| | same for all possible or left undefined outcomes. |

*“ALL” is not necessarily a dialog outcome, but may be used to initiate an action based on all possible outcomes. For example, when “ALL” is specified, the same action is taken for a dialog outcome of “MATCH,” “NO MATCH,” or “NO INPUT.”

WSDML Structure:

A WSDML document is organized via <wsdml> element:

<?xml version=“1.0” encoding=“utf-8” ?>
<wsdml>
</wsdml>

Structurally, a WSDML document includes the following major groups:

| | |
|---|---|
| <applications> | to describe entry points and other attributes such as |
| | language, voice persona, etc., of logically |
| | distinct applications. |
| <audiolist> | to describe audio prompt lists used in the application. |
| <inputs> | to describe user inputs in the form of speech and |
| | DTMF commands. |
| <overrides> | to describe custom brand and corporate account specific |
| | dialog name, touch-tone commands and prompt name |
| | overrides. |
| <dialogs> | to describe voice application dialog states and |
| | corresponding prompts. |
| <events> | to define dialog transitions as a reaction to certain events. |

```
<?xml version=“1.0” encoding=“utf-8” ?>
<wsdml>
  <applications>
    <application name=“StoreLocator” start=“StartDialog”
  path=“./”
        url=“” language=“en-US” voicepersonality=“Kate”
          voicegender=“Female” />
    </application>
  </applications>
    <events>
  </events>
  <audiolist>
  </audiolist>
  <inputs>
  </inputs>
  <overrides>
  </overrides>
  <dialogs>
  </dialogs>
  </wsdml>
```

Other currently defined elements are used within the WSDML groups defined above.

Dialog element: <dialog>.

Prompt elements: <prompts>, <prompt>, <audio>.

Input elements: <grammar-source>, <slots>, <slot>, <commands>, <command>, <dtmf-formats>, <dtmf-format>.

Transitional elements: <actions>, <action>, <goto>, <target>, <return>.

Logic elements: <if>/<elseif>/<else>, <vars>, <var>.

WSDML Elements

This section provides detailed information about each WSDML element including:

(a) Syntax: how the element is used.

(b) Description of attributes and other details.

(c) Usage: information about parent/child elements.

(d) Examples: short example to illustrate element usage.

<action> <actions>

| Syntax | <actions> | |
|---|---|---|
| | <action > | |
| | outcome = “noinput \| nomatch \| match” | |
| | goto = “nextDialogName \| quit ” | |
| | return = “previousDialogName \| self \| prev \| 2 \| 3 ...” | |
| | command = “string” | |
| | digit-confidence=”integer” | |
| | speech-confidence-threshold=” low \| medium \| high ” | |
| | confirm=”string” | |
| | nomatch-reason=”confirmation \| recognition \| application” | |
| | Child_elements | |
| | </action> | |
| | <action > | |
| | .... | |
| | </action> | |
| | </actions> | |
| Description | Specifies dialog transitions depending on the current dialog outcome and the | |
| | caller command. Commands are defined only for ‘match’ outcome. Audio | |
| | included in the action is queued to play first in the next dialog (the list of | |
| | queued audio components is played by the platform upon the first listen | |
| | command). | |
| | Special value _quit in goto property correspond to quitting the | |
| | application if requested by the caller Unlike goto, property return is | |
| | used to go back in the dialog stack to a previous dialog by using its | |
| | name as value: return = “DialogName”. Special values _prev, _self, | |
| | 2, ...N can be used with return | |
| | speech-confidence-threshold At the command level, if the | |
| | recognition result contains the effective confidence for a given | |
| | command lower then the value of “speech-confidence-threshold” | |
| | property, a confirmation dialog is called based on the dialog name | |
| | value in “confirm” property. Low, medium, high confidence | |
| | thresholds are speech platform specific and should be | |
| | configurable. | |
| | This method is used when at least two commands of the current | |
| | dialog require different confidence or two different confirmation sub- | |
| | dialogs are used. Normally, more destructive (delete message) or | |
| | disconnect (“hang-up”) commands require higher confidence | |
| | compared to other commands within the same menu/grammar. | |
| | digit-confidence In digits only mode or when digits are entered in | |
| | speech mode, the confirmation dialog is entered if the number of | |
| | digits entered is greater or equal to digit-confidence property value | |
| | nomatch-reason This property is defined for nomatch outcome | |
| | only. It allows to play different audio and/or transition to different | |
| | dialogs depending on the reason for nomatch: | |
| | confirmation user did not confirm recognized result | |
| | recognition user input was not recognized | |
| | application outcome nomatch was generated by the | |
| | application business logic | |
| | confirm This property contains the name of the confirmation dialog | |
| | which is called based on digit or speech confidence conditions | |
| | described above. If the confirmation dialog returns outcome | |
| | “nomatch”, then the final “nomatch” dialog outcome is set and the | |
| | corresponding “nomatch” action is executed. In case of “match” | |
| | outcome from the confirmation dialog, the final “match” outcome is | |
| | assumed and the corresponding command action is executed in the | |
| | parent dialog. | |
| | Notes: | |
| | 1) “speech-confidence-threshold”, “digit-confidence”, “confirm” properties set at | |
| | the actions command level, overwrite the same properties set at the dialog | |
| | level. | |
| | 2) If <action> does not contain any transitional element (goto or return), | |
| | return = “_self” is assumed by default. There is an infinite loop protection in | |
| | wsdml interpreter, so eventually (after many iterations) any dialog looping | |
| | to _self will cause the application to quit. | |
| Usage | Parents | Children |
| | <dialog> | <audio> <if> <goto> <return> |

| | |
|---|---|
| Example | <actions> |
| | <action outcome=“nomatch” return=“_self” /> |
| | <action outcome=“nomatch” return=“_self” nomatch-reason=”confirmation”> |
| | <audio src=”Sorry about that” /> |
| | <action> |
| | <action outcome=“noinput” goto=“Goodbye” /> |
| | <action command=“cancel” return=“_prev” /> |
| | <audio name=“CommonUC.vc_cancelled”/> |
| | </action> |
| | <action command=“goodbye” speech-confidence-threshold=”high” |
| | confirm=“ConfirmGoodbye” > |
| | <if var=”IsSubscriber” > |
| | <audio name=“CommonUC.vc_goodbye” /> |
| | </if> |
| | goto target=”_quit” |
| | </action> |
| | <action command=“listen_to_messages” goto=“ListenToMessages” /> |
| | <action command=“make_a_call” goto=“MakeACall” /> |
| | <action command=“call_contact” goto=”CallContact”> |
| | <action command=“call_contact_name” goto=”CallContactName”> |
| | <action command=“call_contact_name_at” goto=”CallContactNameAt”> |
| | </action> |
| | </actions> |

<applications>,<application>

| Syntax | <wsdml > | |
|---|---|---|
| | <applications> | |
| | <application | |
| | name=”string” | |
| | start = “string” | |
| | path=”string” | |
| | url=”string” | |
| | language = “en-US \| en \| fr \| fr-CA\| es\|... ” | |
| | voice-personality = “string” | |
| | voice-gender=”Male \| Female” | |
| | /> | |
| | </applications> | |
| | </wsdml> | |
| Description | The <application> element may include the following properties: | |
| | start defines the starting dialog name for a given application | |
| | path provides the path to the directory containing the application dialog files | |
| | in wsdml format | |
| | url a link to the site containing wsdml documents for a given application | |
| | language (optional) defines the audio prompt language for a single language | |
| | application or the default language if the application includes dialogs in more | |
| | then one language | |
| | voice-personality (optional) defines the default personality, e.g. “Kate”. | |
| | Personality may or may not be associated with a particular language | |
| | voice-gender (optional) defines the gender of the recoded voice and by | |
| | association the gender of generated voice via TTS | |
| Usage | Parents | Children |
| | <wsdml> | None |

| | |
|---|---|
| Example | <wsdml> |
| | <applications> |
| | <application name=“IvyStoreLocator” start=“IvyStart” path=“./” |
| | url=“” language=“en- |
| | US” voice-personality=“Kate” voice-gender=“Female” /> |
| | <application name=“AcmeLocator” start=“AcmeStart” path=“./” url=“” |
| | language=“en-US” voice-personality=“Kate” voice-gender=“Female” /> |
| | </applications> |
| | <dialogs group=“StoreLocatorApplications”> |
| | <dialog name=“IvyStart” flush-digits=“true” inherit=“PurePlayTemplate”> |
| | <prompts> |
| | <prompt outcome=“init”> |
| | <audio name=“StoreLocator.lc_welcome_ivy” /> |
| | </prompt> |
| | </prompts> |
| | <actions> |
| | <action outcome=“all” goto=“StoreLocatorGreetings” /> |
| | </actions> |
| | </dialog> |
| | <dialog name=“NikeStart” flushdigits=“true” inherit=“PurePlayTemplate”> |
| | <prompts> |
| | <prompt outcome=“init”> |
| | <audio name=“StoreLocator.lc_welcome_acme” /> |
| | </prompt> |
| | </prompts> |
| | <actions> |
| | <action outcome=“all” goto=“StoreLocatorGreetings” /> |
| | </actions> |
| | </dialog> |
| | </dialogs> |
| | </wsdml> |

<audio>

| | | |
|---|---|---|
| Syntax | <audio | |
| | | name = “string” |
| | | src = “string” |
| | | text = “string” |
| | | var = “string” |
| | | comment = “string” |
| | </audio> | |

| | |
|---|---|
| Description | Specifies audio component properties, such as the name, the optional file source and |

the textual content. If a file source is not specified, it is looked up in the
<audiolist>, then if not found there, the text is synthesized via the TTS
engine. If the audio source can only be determined during run-time, <var>
property is used to pass a variable audio component name content. See
<var> section. To make dialog flow more transparent, comment property can
be used to describe the audio content in cases where it is set via var
property during runtime.

| | | |
|---|---|---|
| Usage | Parents | Children |
| | <prompt> <action> <audiolist> | |

| | |
|---|---|
| Example | <audiolist language=“en-US” format=“pcm” rate=“8” > |
| | <audio name=“CommonUC.another_party” src=“vc_another_party” |
| | text=“Would you like to call another party?” /> |
| | ... |
| | </audiolist> |
| | ... |
| | <dialog name=“DialOutcome” inherit=“PurePlayDialogTemplate” flush-dtmf=“true”> |
| | <vars> |
| | <var type=“audio” name=“DialOutcome” /> |
| | </vars> |
| | <prompts> |
| | <prompt outcome=“init” > |
| | <audio var=“DialOutcome”> comment=”Busy, no answer, call |
| | waiting or nothing is played here depending on the call completion status” /> |
| | <audio name = “CommonUC.another_party” /> |
| | </prompt> |
| | </prompts> |
| | ... |
| | <dialog> |

<audiolist>

| | | |
|---|---|---|
| Syntax | <audiolist | |
| | | name = “string” |
| | | language = “en-US \| en \| fr \| fr-CA\| es\|... ” |
| | | format = “pcm \| adpcm \| gsm \| mp3...” |
| | | rate = “6 \| 8” |
| | | Child_elements |
| | </audiolist> | |

| | |
|---|---|
| Description | Describes the list of pre-recorded audio files and their common properties. |
| | Audiolist properties: |

Name: usually identifies if the list belongs to an application or is a general
purpose list
Language: ISO 639-1, ISO 639-2 standard language codes are used
Audio format: one of pcm (default for MSP), adpcm (default for legacy TDM
platform), gsm, mp3, etc.
Sampling rate: 6 (legacy TDM default) or 8 (MSP default) KHz

| | Normally, an application will have several audio lists defined, such as Standard for | |
|---|---|---|
| | days, numbers, dates, money etc., CommonUC for prompts common to all | |
| | UC applications, VirtualPBXApp prompts only found in virtual PBX, | |
| | corporate applications, ConferencingApp conferencing only prompts, | |
| | FaxApp fax only prompts, etc | |
| Usage | Parents | Children |
| | <wsdml> | <audio> |

| | |
|---|---|
| Example | <audiolist name=”CommonUC” format=“pcm” rate=“8” language=“en-US” > |
| | <audio name=“CommonUC.vc_sorry_about_that” |
| | src=“vc_sorry_about_that” text=“Sorry about that.” |
| | /> |
| | <audio name=“CommonUC.vc_cancelled” src=“vc_cancelled” |
| | text=“Cancelled.” |
| | /> |
| | <audio name=“CommonUC.vc_is_this_ok” src=“vc_is_this_ok” |
| | text=“Is this okay?” |
| | /> |
| | <audio name=“CommonUC.vc_press1_or_2” src=“vc_press1_or_2” |
| | text=“Press one if correct or two if incorrect?” |
| | /> |
| | <audio name=“CommonUC.vc_didnt_understand” |
| | src=“vc_didnt_understand” |
| | text=“I am sorry, I didn't understand you.” |
| | /> |
| | </audiolist> |

<command>, <commands>

| | | |
|---|---|---|
| Syntax | <command | |
| | | name = “string” |
| | | code = “string” |
| | | dtmf = ”string” |
| | | Child_elements |
| | /> | |

| Description | This element defines dtmf and symbolic to numeric command map for a given user | |
|---|---|---|
| | input descriptor. The optional property code describes the numeric value returned | |
| | from the grammar to the application if any. Normally, grammars should return | |
| | symbolic command value upon speech or dtmf input. If a spoken command does not | |
| | have a dtmf equivalent, the latter can be omitted. | |
| Usage | Parents | Children |
| | <input> | <test-cases>, <test-case> |

| | |
|---|---|
| Example | <input name=”MainMenu” grammar-source=“.MENU”> |
| | <slots> |
| | <slot name=“menu” type=“command” /> |
| | </slots> |
| | <commands> |
| | <command name=“yes” code=“1” dtmf=“1”> |
| | <test-cases> |
| | <test-case name=”USMale”> |
| | <audio name=“SpeechSamples.yes1_us_english_male” /> |
| | <audio name=“SpeechSamples.yes2_us_english_male” /> |
| | </test-case> |
| | <test-case name=”USFemale”> |
| | <audio name=“SpeechSamples.yes1_us_english_female” /> |
| | <audio name=“SpeechSamples.yes2_us_english_female” /> |
| | </test-case> |
| | <test-case> |
| | <audio name=“SpeechSamples.random_speech_us_english” /> |
| | <audio name=“SpeechSamples.3sec_white_noise” /> |
| | <audio name=“SpeechSamples.silence” /> |
| | </test-case> |
| | </test-cases> |
| | </command> |
| | </commands> |
| | </input> |
| | ... |

<dialog>, <dialogs>

| Syntax | <dialog | |
|---|---|---|
| | name=“string” | |
| | template=“true \| false” | |
| | inherit=”string” | |
| | input=”string” | |
| | noinput-command=“string” | |
| | noinput-timeout=“string” | |
| | inter-digit-timeout=“string” | |
| | flush-digits=“true \| false” | |
| | term-digits=“string” | |
| | detect-digit-edge=”string” | |
| | detect-speech=“true \| false” | |
| | detect-digits=“true \| false” | |
| | detect-fax=“true \| false” | |
| | noinput-count=“integer” | |
| | nomatch-count=“integer” | |
| | digit-confidence=”integer” | |
| | speech-end-timeout=“string” | |
| | speech-barge-in=“true \| false” | |
| | speech-max-timeout=“string” | |
| | speech-confidence-threshold=”low \| medium \| high” | |
| | play-max-time=”string” | |
| | play-max-digits=“integer” | |
| | play-speed=”string” | |
| | play-volume=”string” | |
| | record-beep=”true \| false” | |
| | record-max-silence=”string” | |
| | record-max-no-silence=”string” | |
| | record-max-time=”string” | |
| | record-max-digits=“integer” | |
| | collect-max-digits=”integer” | |
| | collect-max-time=”string” | |
| | Child_elements | |
| | </dialog> | |
| Description | Describes important properties and elements of speech dialog as it is defined above | |
| | (see WSDML Dialog Concept). The dialog properties are not persistent and are reset | |
| | automatically to their defaults upon any dialog entry and require explicit setting within | |
| | the dialog whenever different property values are required. | |
| | name* Name of the dialog | |
| | template* If “true”, defines the dialog as a template dialog only | |
| | designed for other dialogs to inherit from. All dialog properties and child | |
| | elements can be inherited. Normally, only typical dialog properties, | |
| | prompts and actions are inherited. | |
| | inherit* Defines a dialog template name to inherit the current dialog | |
| | properties and elements | |
| | input Refers to the name of the user input descriptor which is required | |
| | in the dialog to process user's input (see input tag). The presence of the | |
| | input property in the dialog properties is required for PlayListen or Listen | |
| | execution when caller input is expected. If the input property is absent, | |
| | simple Play will be executed and no input will be expected within the | |
| | dialog | |
| | term-digits A string of telephone keypad characters. When one of them | |
| | is pressed by the caller, collectdigits function terminates. Normally not | |
| | used in play or record function. | |
| | flush-digits* If “true”, flush any digits remaining in the buffer, before | |
| | playing the initial dialog prompt (default is “false”) | |
| | detect-digit-edge Sets dtmf/mf trailing or leading edge to trigger digit | |
| | detection | |
| | detect-speech* If “true”, enables speech detection (default is “true”) | |
| | detect-digits* If “true”, enables digits detection (default is “true”) | |
| | detect-fax* If “true”, enables fax tone detection (default is “false”) | |
| | noinput-timeout Maximum time allowed for the user input (speech or | |
| | digits) in seconds (s) or milliseconds (ms) after the end of the | |
| | corresponding prompt | |
| | inter-digit-timeout Maximum time allowed for the user to enter more | |
| | digits once at least one digit was entered; in seconds (s) or milliseconds | |
| | (ms) | |
| | noinput-command Some dialogs, designed as list iterators, require | |
| | noinput outcome to be treated as one of the commands, e.g., “next”. | |
| | This property allows action for noinput behave as if a given command | |
| | was issued by the user | |
| | noinput-count Maximum number of iterations within the current dialog | |
| | while no user input is received | |
| | nomatch-count Maximum number of iterations within the current dialog | |
| | while invalid, unexpected or unconfirmed user input is received | |
| | digit-confidence Minimum number of digits the caller must enter within | |
| | the parent dialog before the confirmation sub-dialog is entered. The | |
| | default value is 0, which effectively disables confirmation of touch-tone | |
| | entries. Normally, this property is used when long digit sequences (e.g. | |
| | phone, credit card numbers) must be confirmed | |
| | speech-end-timeout* Maximum time in seconds (s) or milliseconds | |
| | (ms) of silence after some initial user speech before the end of speech is | |
| | detected (default is 750 ms). Note: if speech detection is enabled, | |
| | speech parameters overwrite potentially conflicting digits parameters, | |
| | e.g. speech-max-timeout is higher priority then collect-max-time | |
| | speech-barge-in* If “true”, allows the user to interrupt a prompt with a | |
| | speech utterance (default is “true”) | |
| | speech-max-timeout* Maximum duration in seconds (s) or | |
| | milliseconds (ms) of continuous speech by the user or speech-like | |
| | background noise | |
| | speech-confidence-threshold Defines the level (always, low, medium | |
| | or high) of speech recognition result confidence, below which a | |
| | confirmation sub-dialog is entered, if it is defined in the parent dialog. | |
| | The value of this property is platform/speech engine specific, but | |
| | normally is within 35-45 range. | |
| | digit-barge-in* If “true”, allows the user to interrupt a prompt with a digit, | |
| | otherwise if “false” the prompt will be played to the end ignoring dtmfs | |
| | entered by the user (default is “true”) | |
| | collect-max-digits Maximum number of digits before termination of | |
| | collect-digits function. The default is 1. | |
| | record-max-time Maximum time allowed in seconds before termination | |
| | of record function (default is platform specific). Normally, this property | |
| | requires attention when (conference) call recording type feature | |
| | requires longer then normal record time. | |
| | play-speed Speed of audio playback (mostly used in voicemail): low, | |
| | medium, high (default is medium) | |
| | play-volume Volume of audio playback: low, medium, high (default is | |
| | medium) | |
| | record-max-silence Silence time in seconds (s) or milliseconds (ms) | |
| | before recording terminates (default is 7 s) | |
| | record-max-no-silence Non-silence time in seconds (s) or | |
| | milliseconds (ms) before recording terminates (default is 120 s) | |
| | record-beep If “true”, play a recognizable tone to signal the caller that | |
| | recording is about to begin (default is “true”) | |
| Usage | Parents | Children |
| | <wsdml>, <dialogs> | <prompts>, <actions>, <vars> |

| | |
|---|---|
| Example | <?xml version=“1.0” encoding=“utf-8” ?> |
| | <wsdml> |
| | <applications> |
| | <application=“mcall” start=“StartDialog” path=”/usr/dbadm/mcall/dialogs” /> |
| | </applications> |
| | ... |
| | <audiolist> |
| | ... |
| | </audiolist> |
| | <dialogs> |
| | <dialog name=“PlayListenDialogTemplate” template=“true” |
| | speech-timeout=“0.75” |
| | speech-barge-in=“true” |
| | speech-max-timeout=“5” |
| | noinput-timeout=“5” |
| | inter-digit-timeout=“5” |
| | flush-digits=“false” |
| | term-digits=“” |
| | detect-speech=“true” |
| | detect-digits=“true” |
| | detect-fax=“false” |
| | noinput-count=“2” |
| | nomatch-count=“2” |
| | > |
| | </dialog> |
| | <dialog name=“AddParty” inherit=“PlayListenDialogTemplate” |
| | nomatch-count=“3” speech-max-timeout=“20” |
| | speech-end-timeout=“1.5” collect-max-digits=“10” |
| | term-digits=“#” speech-confidence-threshold=”low” |
| | digit-confidence=7 input=”PhoneAndName” > |
| | <vars> |
| | <var type=“audio” name=“Invalid_name_or_number” /> |
| | <var type=“text” name=“NameOrNumber” /> |
| | </vars> |
| | <prompts> |
| | <prompt outcome=“init” > |
| | <audio name=“CommonUC.vc_name_or_number” /> |
| | </prompt> |
| | <prompt outcome=“noinput” mode=“speech”> |
| | <audio name=“CommonUC.havent_heard_you”/> |
| | <audio name=“CommonUC.vc_say_phone_or_name” |
| | /> |
| | </prompt> |
| | <prompt outcome=“noinput” mode=“dtmf”> |
| | <audio name=“CommonUC.havent_heard_you ” /> |
| | <audio name=“CommonUC.vc_phone_few_letters”/> |
| | </prompt> |
| | <prompt outcome=“nomatch” mode=“speech” input-type=“speech”> |
| | <audio name=“CommonUC.vc_didnt_understand”/> |
| | <audio name=“CommonUC.vc_say_phone_or_name” /> |
| | </prompt> |
| | <prompt outcome=“nomatch” mode=“speech” input-type=“dtmf”> |
| | <audio var=“Invalid_name_or_number” /> |
| | <audio name=“CommonUC.vc_say_phone_or_name” |
| | /> |
| | </prompt> |
| | <prompt outcome=“nomatch” mode=“dtmf”> |
| | <audio var=“Invalid_name_or_number” /> |
| | <audio name=“CommonUC.vc_phone_or_few_letters” |
| | /> |
| | </prompt> |
| | </prompts> |
| | <actions> |
| | <action outcome=“noinput” return=“_prev”/> |
| | <action outcome=“nomatch” return=“_self” /> |
| | <action outcome=“nomatch” return=“_prev” /> |
| | <action command=“help” return=“_self”> |
| | <audio name=“CommonUC.vc_add_party_help” </audio> |
| | </action> |
| | <action command=“cancel” confirm=”ConfirmCancel” |
| | speechconfidence=”low” return=“_prev”> |
| | <audio name=“CommonUC.vc_cancelled” /> |
| | </action> |
| | <action outcome=“match” goto=“DialingNumber” > |
| | </actions> |
| | </dialog> |
| | </dialogs> |
| | </wsdml>. |

<event>, <events>

| | | |
|---|---|---|
| Syntax | <event | |
| | | type = “CallWaiting \| MessageWaiting ” |
| | | handler = “string” |
| | </> | |

| Description | Defines events and event handlers in the form of dialogs constructed in a certain way | |
|---|---|---|
| | (to return to previous dialogs irrespective of user input). Events that require caller | |
| | detectable dialogs are currently include CallWaiting and MessageWaiting. Events that | |
| | do not require caller detectable actions, e.g. caller hang-up event, do not have to be | |
| | described as part of <events> element. | |
| Usage | Parents | Children |
| | <wsdml> | none |

| | |
|---|---|
| Example | <events> |
| | <event type=“CallWaiting” handler=“AppCallWaiting” /> |
| | <event type=“MessageWaiting” handler=“AppMessageWaiting” /> |
| | </events> |

<if> <elseif><else>

| Syntax | <if cond = “string”> | |
|---|---|---|
| | Child_elements | |
| | <elseif cond = “string”/> | |
| | Child_elements | |
| | <else/> | |
| | Child_elements | |
| | </if> | |
| | cond = “var \| slot” | |
| Description | Currently, cond includes var or slot element. To simplify the cond evaluator, only “=” | |
| | operator is defined. When cond attribute evaluates to true, then the audio part or goto | |
| | transition between the <if> and the next <elseif>, <else>, or </if> is processed. No | |
| | nested <if> are allowed in wsdml. Complex conditions shall be handled by business | |
| | logic software and/or grammar interpreters normally supplied as part of core speech | |
| | engines. | |
| Usage | Parents | Children |
| | <action> <prompt> | <audio> <goto> |

| | |
|---|---|
| Example | <vars> |
| | <var type=“boolean” name=“FollowMe” /> |
| | </vars> |
| | ... |
| | <prompt outcome=“noinput” count=“1”> |
| | <if var=“FollowMe” > |
| | <audio src=“menu1.pcm” |
| | text=”Say, listen to messages, make a call, transfer my |
| | calls, stop following me, send message, check my |
| | email, check my faxes, set my personal options, |
| | access saved messages or restore deleted |
| | messages.” |
| | /> |
| | <else /> |
| | <audio src=“menu2.pcm” |
| | text=”Say, listen to messages, make a call, transfer my |
| | calls, start following me, send message, check my |
| | email, check my faxes, set my personal options, |
| | access saved messages or restore deleted |
| | messages.” |
| | /> |
| | </if> |
| | </prompt> |
| | ... |
| | ... |
| | <action command=“call_contact” > |
| | <if slot=“param2” > |
| | <goto target=“CallContactNameAt” /> |
| | <elseif slot=“param1” /> |
| | <goto target=“CallContactName” /> |
| | <else /> |
| | <goto target=“CallContact” /> |
| | </if> |
| | </action> |

<input>, <inputs>

| Syntax | <input> | |
|---|---|---|
| | name = “string” | |
| | grammar-source = “string” | |
| | Child_elements | |
| | </input> | |
| Description | Both precompiled and inline (JIT-just in time) grammars are supported in wsdml | |
| | framework. Static or dynamic grammars for the entire application are kept in separate | |
| | precompiled files which can be referenced by name or URL. <input> tag specifies | |
| | attributes name as an internal wsdml reference and grammar-source as a | |
| | reference to the actual pre-compiled grammar static or dynamic.. Attribute grammar- | |
| | source can contain an external grammar identifier, e.g., “.MENU” from the compiled | |
| | static grammar package or URL to a dynamic grammar. Child element <grammar- | |
| | source> is also supported. <grammar-source> tag and <grammar-source> | |
| | attribute are mutually exclusive. The purpose of <grammar-source> tag is to enable | |
| | JIT grammar inclusion. A JIT grammar can be in any standard grammar format, such | |
| | as grXML or GSL.. Any existing JIT grammar can be inserted into <grammar-source/> | |
| | without any modifications. Child element <slots> describes slots that are | |
| | requested by the application and returned by the speech recognizer filled or unfilled | |
| | based on the user utterance; <commands> describes the list of commands and their | |
| | corresponding dtmf and optional return codes. Commands are used to consolidate | |
| | different types of speech and dtmf input and transfer control to specific dialogs. | |
| | <dtmf-formats> is used to describe dtmf commands expected at a given menu which | |
| | contain different number of digits, other logical conditions to optimize and automate | |
| | variable dtmf command processing. | |
| Usage | Parents | Children |
| | <wsdml>, <inputs> | <grammar-source>, <slots>, |
| | | <commands>, <dtmf-formats> |

| | |
|---|---|
| Example | <inputs> |
| | <input name=”MainMenu” grammar-source=“.MENU”> |
| | <slots> |
| | <slot name=“command” type=“command”/> |
| | </slots> |
| | <commands> |
| | <command name=”check_voicemail” code=”10” dtmf=”10” /> |
| | </commands> |
| | <dtmf-formats> |
| | <dtmf-format prefix=“#” count=“3” terminator=“” /> |
| | <dtmf-format prefix=“*” count=“16” terminator=“#” /> |
| | <dtmf-format prefix=“9” count=“0” /> |
| | <dtmf-format prefix=“” count=“2” /> |
| | </dtmf-formats> |
| | </input> |
| | <input name=“YesNoRepeat” > |
| | <grammar-source type=”grxml” > |
| | <grammar |
| | xmlns=“http://www.w3.org/2001/06/grammar” |
| | xmlns:nuance=“http://voicexml.nuance.com/grammar” |
| | xml:lang=“en-US” |
| | version=“1.0” |
| | root=“YesNoRepeat” |
| | mode=“voice” |
| | tag-format=“Nuance”> |
| | <rule id=“YesNoRepeat” scope=”public”> |
| | <one-of lang-list=“en-US”> |
| | <item> yes <tag> <![CDATA[ <menu “1”> ]]> </tag> </item> |
| | <item> no <tag> <![CDATA[ <menu “2”> ]]> </tag> </item> |
| | <item> |
| | <ruleref uri=“#START_REPEAT_DONE”/> <tag><![CDATA[ |
| | <menu $return>]]> </tag> |
| | </item> |
| | </one-of> |
| | </rule> |
| | <rule id=“START_REPEAT_DONE” scope=“public”> |
| | <one-of> |
| | <item> repeat |
| | <tag> return (“4”) </tag> |
| | </item> |
| | <item> start over |
| | <tag> return (“7”) </tag> |
| | </item> |
| | <item> i am done |
| | <tag> return (“9”) </tag> |
| | </item> |
| | </one-of> |
| | </rule> |
| | </grammar> |
| | </grammar-source> |
| | </input> |
| | </inputs> |

<prompt>, <prompts>

| Syntax | <prompts> | |
|---|---|---|
| | <prompt | |
| | outcome = “init \| noinput \| nomatch” | |
| | count = “string” | |
| | mode = “speech \| digits” | |
| | input-type = “speech \| digits” | |
| | ... | |
| | Child_elements | |
| | </prompt> | |
| | </prompts> | |
| Description | Defines prompt properties and audio elements it is comprised of. | |
| | outcome specifies the state of a regular dialog or confirmation dialog when | |
| | a given prompt must be played | |
| | init outcome is set upon the entry into the dialog | |
| | noinput outcome occurs when some user input was expected but | |
| | was not received during a specified time period | |
| | nomatch outcome occurs when some unexpected or invalid user | |
| | input was received in the form of spoken utterance or touch-tone | |
| | command; match outcome is only used at the actions level | |
| | count specifies the current dialog iteration count when a given prompt must | |
| | be played. Maximum number of iterations for both noinput, and nomatch | |
| | outcomes is normally defined as dialog template properties which are | |
| | inherited by similar behaving dialogs. String ‘last’ is also defined for this | |
| | property which helps when it is necessary to play certain prompts upon | |
| | completing the last dialog iteration | |
| | mode specifies one of two dialog modes: speech or digits. The mode can | |
| | be user or system selectable depending on the application and is used to | |
| | play relevant prompts. The speech mode allows user interaction via speech | |
| | or digits and normally requires prompts suggesting just the speech input, | |
| | rarely overloading the user with optional touch-tone info. The digits mode | |
| | allows user interaction via touch-tones only (speech recognition is turned off) | |
| | and requires prompts suggesting touch-tone input. | |
| | Input-type specifies the type of input by the user: speech or digits. The | |
| | dialog context may require to play a different prompt depending on what the | |
| | user input was irrespective of the current mode. E.g., if the initial prompt | |
| | requests a speech command, but the user entered a touch-tone command, | |
| | the next prompt within the same dialog might suggest a touch-tone | |
| | command. | |
| | Notes: | |
| | If a dialog contains prompts without defined outcome, they will match | |
| | any outcome and will be queued for playback in the order they are listed | |
| | along with prompts matching a given specific outcome | |
| | For a given outcome, if no prompts for specific dialog iterations are | |
| | defined, while the dialog noinput-count or nomatch-count properties are | |
| | set greater then 1, the prompt for the given outcome or without any | |
| | outcome defined will be repeated for every dialog iteration | |
| Usage | Parents | Children |
| | <dialog> | <audio> |

| Example | <prompts> | |
|---|---|---|
| | <prompt outcome=“init”> | |
| | <audio src=“what_number.pcm” text=” What number should I dial?” | |
| | /> | |
| | </prompt> | |
| | <prompt outcome=“noinput” mode=“speech” count=“1”> | |
| | <audio src=“havent_heard_you.pcm” text=“I haven't heard from you” | |
| | /> | |
| | <audio src=“say_number.pcm ” text=” Please, say or touch-tone | |
| | the phone number including the area code.” /> | |
| | </prompt> | |
| | <prompt outcome=“noinput” mode=“digits” count=“1”> | |
| | <audio src=“havent_heard_you.pcm ” | |
| | text=”I haven't heard from you.” | |
| | /> | |
| | <audio src=“enter_number.pcm ” | text=”Please, enter the phone |
| | | number including the area |
| | | code.” |

```
        />
    </prompt>
    <prompt outcome=“noinput” mode=“speech” count=“2”>
        <audio src=“are_you_there.pcm” text=”Are you still there?”/>
        <audio src=“say_number.pcm” text=”Please, say or
touch-tone the_phone touch-tone the_phone number including the area code.” />
    </prompt>
    <prompt outcome=“noinput” mode=“digits” count=“2”>
        <audio src=“are_you_there.pcm” text=”Are you still there?”/>
        <audio src=“enter_number.pcm” text=”Please, enter the phone number
including the area code. “
        />
    </prompt>
  <prompt outcome=“nomatch” mode=“speech”
  count=“1” input-type=“speech”>
      <audio src=“i_am_not_sure_what_you_said.pcm” text=”I
am not sure what you said” />
  </prompt>
  <prompt outcome=“nomatch” mode=“speech” count=“1” input-type=“digits”>
      <audio src=“number_not_valid.pcm” text=”Number is not valid”/>
      <audio src=“enter_ten_dgt_number.pcm” text=”Please, enter a ten-digit
                phone number starting with the area code.”
      />
  </prompt>
  <prompt outcome=“nomatch” mode=“speech” count=“2”>
      <audio src=“sorry_didnt_hear.pcm” text=”Sorry, I didn't hear
that number right.”
      />
      <audio src=“say_number.pcm” text=”Please, say or touch-tone
the_phone number including the area code or say cancel.”
      />
    </prompt>
</prompts>
```

<override>, <overrides>

| Syntax | <override | |
|---|---|---|
| | brand = “string” | |
| | corporate-account = “string” > | |
| | <dialog name = “oldname” replace=”newname” /> | |
| | <audio name=“oldname” replace=“newname” /> | |
| | <command input=“foo” name=“foobar” | |
| | code=“old-code” dtmf=“new-dtmf” /> | |
| | </override> | |
| Description | <overrides> is an optional section defined as part of the root document. Depending on | |
| | brand and/or corporate account, <override> specifies a dialog, audio file or dtmf | |
| | command to replace compared to default. For a example, a particular service brand | |
| | offered to the user base that arrived from an old legacy voice platform, may require | |
| | support of the same old dtmf commands, so that the user migration could be | |
| | accomplished easier | |
| Usage | Parents | Children |
| | <wsdml> <overrides> | Override specific : <dialog>, |
| | | <command>, <audio> |

| | |
|---|---|
| Example | <overrides> |
| | <override brand=“14”> |
| | <dialog name=“DialogDefault” replace=“DialogCustom” /> |
| | <audio name=“CommonUC.vp_no_interpret” |
| | replace=“CommonUC.vp_no_interpret_new/> |
| | <command input=“MainMenu” name=“wait_minute” |
| | code=“95” dtmf=“95” /> |
| | </override> |
| | <override corporate-account=“12000”> |
| | .... |
| | </override> |
| | </overrides> |

<slot>, <slots>

| | |
|---|---|
| Syntax | <slot |
| | name = “string” |
| | type = “string” |
| | </slot> |
| Description | <slot> elements are used within the parent grammar element to specify the data |
| | elements requested from the speech server by the application. These data elements |
| | are filled from the user spoken utterance according to the grammar rules. The slot |
| | serving as a command attribute is specified using type = “command” property. |
| | Internally, dialog state machine will retain the last dialog speech result context |
| | including the command value as well as parameter values. This enables command |
| | and parameter based dialog transitions in <actions> section of <dialog> |
| Usage | Parents Children |
| | <input> none |
| Example | <input name=”Menu” grammar-source=“.MENU”> |
| | <slots> |
| | <slot name=“menu” type=“command” /> |
| | <slot name=“param1” /> |
| | <slot name=“param2” /> |
| | </slots> |
| | <commands> |
| | <command name=”listen_to_messages” code=”10” dtmf=”10” /> |
| | <command name=”lmake_a_call” code=”20” dtmf=”20” /> |
| | <command name=”call_contact” code=”24” dtmf=”24” /> |
| | </commands> |
| | </input> |
| | ... |
| | <actions> |
| | <action command=“listen_to_messages” goto=“ListenToMessages” /> |
| | <action command=“make_a_call” goto=“MakeACall” /> |
| | <action command=“call_contact” > |
| | <if slot=“param2” > |
| | <goto target=“CallContactNameAt” /> |
| | <elseif slot=“param1” /> |
| | <goto target=“CallContactName” /> |
| | <else /> |
| | <goto target=“CallContact” /> |
| | </if> |
| | </action> |
| | </actions> |

<test-case>, <test-cases>

| | | |
|---|---|---|
| Syntax | <test-case | |
| | | name = “string” |
| | | Child_elements |
| | /> | |

| Description | This element defines a specific test case used by a test application simulating real | |
|---|---|---|
| | user. Such test application can be automatically generated by WSDML test | |
| | framework. It will traverse the target application dialog tree using different test cases | |
| | to simulate different types of users, such as male, female, accented speech, as well | |
| | as different type of user input, such as noise, silence, hands-free speech, speaker | |
| | phone, etc. The audio elements within a particular test case for a particular command | |
| | may contain multiple utterances reciting a given command in various ways to achieve | |
| | specific testing goals as outlined above. As the testing application navigates the | |
| | dialog tree, it will randomly (or based on a certain algorithm) select from a preset | |
| | number of command utterances, noise and silence samples under a given test case, | |
| | thus simulating the real user input. The optional default test case with empty name | |
| | attribute or without a name attribute will be merged with all the specific, named test | |
| | cases. This default test case can include various noises, silence and audio samples | |
| | common to all test cases. | |
| Usage | Parents | Children |
| | <command> | <audio> |

| | |
|---|---|
| Example | <input name=”MainMenu” grammar-source=“.MENU”> |
| | <slots> |
| | <slot name=“menu” type=“command” /> |
| | </slots> |
| | <commands> |
| | <command name=“yes” code=“1” dtmf=“1”> |
| | <test-cases> |
| | <test-case name=”USMale”> |
| | <audio name=“SpeechSamples.yes1_us_english_male” /> |
| | <audio name=“SpeechSamples.yes2_us_english_male” /> |
| | </test-case> |
| | <test-case name=”USFemale”> |
| | <audio name=“SpeechSamples.yes1_us_english_female” /> |
| | <audio name=“SpeechSamples.yes2_us_english_female” /> |
| | </test-case> |
| | <test-case> |
| | <audio name=“SpeechSamples.random_speech_us_english” /> |
| | <audio name=“SpeechSamples.3sec_white_noise” /> |
| | <audio name=“SpeechSamples.silence” /> |
| | </test-case> |
| | </test-cases> |
| | </command> |
| | </commands> |
| | </input> |
| | ... |

<var>, <vars>

| Syntax | <vars | |
|---|---|---|
| | <var | |
| | name = “string” | |
| | type = “boolean \| audio \| text” | |
| | /> | |
| | ... | |
| | </vars> | |
| Description | <var> element describes a variable which must be set by the dialog state machine | |
| | during run-time. Variable type are defined as: | |
| | Boolean | used in <if>, <elseif> |
| | Audio | used in <audio> |
| | Text | used in <audio> while enforcing TTS; no attempt will be made to |

| | find corresponding audio files recorded by a human | |
|---|---|---|
| | <var> element can be used when the dialog audio content, either completely, or | |
| | partially, can only be determined during run-time. Another use of <var> is possible | |
| | within <actions> section as part of <if>, <elseif> evaluator, to define conditional | |
| | dialog control transfer. The content of <var> within the <audio> is first checked | |
| | against the <audiolist> defined for the current application, then, if not found, is treated | |
| | as text to be converted to audio by the available TTS engine. | |
| Usage | Parents | Children |
| | <wsdml> <dialog> | none |

| | |
|---|---|
| Example | <vars> |
| | <var type=“boolean” name=“FollowMe” /> |
| | <var type=”audio” name=”DialOutcome” /> |
| | </vars |
| | <prompts> |
| | <prompt outcome=”init” > |
| | <audio var=“DialOutcome” /> |
| | </prompt> |
| | </prompts> |
| | <actions> |
| | <action outcome=“all” goto=“DialAnotherNumber” /> |
| | </actions> |
| | ... |

<actions> <action>

| Syntax | <actions inherit=”false \| true” > | |
|---|---|---|
| | <action > | |
| | outcome = “noinput \| nomatch \| match \| error \| all \| any” | |
| | goto = “nextDialogName \| _self \| _quit” | |
| | goto-application = “ApplicationName” | |
| | return = “previousDialogName \| _prev \| 2 \| 3 ...” | |
| | command = “string” | |
| | digit-confidence=”integer” | |
| | speech-confidence-threshold=” low \| medium \| high \| integer ” | |
| | speech-rejection-level=”low \| medium \| high \| integer ” | |
| | confirm=”string” | |
| | nomatch-reason=”confirmation \| recognition \| application” | |
| | Child_elements | |
| | </action> | |
| | <action > | |
| | .... | |
| | </action> | |
| | </actions> | |
| Description | Specifies dialog transitions depending on the current dialog outcome and the | |
| | caller command. Commands are defined only for ‘match’ outcome. Audio | |
| | included in the action is queued to play first in the next dialog (the list of | |
| | queued audio components is played by the platform upon the first listen | |
| | command). | |
| | “all”, “any” - these outcome values are used in cases where the resulting | |
| | action/prompt is the same for all possible or left undefined outcomes | |
| | “error” - this outcome value is used where the resulting action/prompt is | |
| | the same for both noinput and nomatch outcomes; it is logically related to | |
| | error-count condition defining the number of dialog iterations with either | |
| | nomatch or noinput outcome | |
| | goto, return Special values _quit and _self of goto property correspond | |
| | to quitting the application and re-entering the same dialog respectively. | |
| | Unlike goto, property return is used to go back in the dialog stack to a | |
| | previously executed dialog by using its name as value: | |
| | return = ”DialogName”. By using “return DialogName” instead of “goto | |
| | DialogName” you allow the target dialog “to be automatically aware” of the | |
| | fact that control is returning to it within the same instance of activity, rather | |
| | then re-entering it in all new instance. Usage of return in those cases where | |
| | it is appropriate enables more efficient business logic. Special values _prev, | |
| | 2, ...N can be used only with return indicating number of steps back | |
| | in dialog stack. It is not recommended to use return “N” outside of very | |
| | special cases when it is known that the number of steps N can not change | |
| | goto-application This property or child element is used to pass control | |
| | from the current, parent application to another, child application. The value | |
| | of goto-application should match the name property of the <application> | |
| | element of the corresponding wsdml application being called. At the business | |
| | logic level a set of parameters can be described in a XML format to pass | |
| | from the parent to the child application (see WSDML framework document | |
| | for more details). Upon returning from the child application, the parent | |
| | application will either restart the same dialog from which the child application | |
| | was invoked, or will proceed to the next dialog if <goto> is defined in the | |
| | same action where <goto-application> is also found. The order of these | |
| | elements within the action is immaterial | |
| | speech-confidence-threshold At the command level, if the recognition | |
| | result contains the effective confidence for a given command lower then the | |
| | value of “speech-confidence-threshold” property, a confirmation dialog is | |
| | called based on the dialog name value in “confirm” property. Low, medium, | |
| | high confidence thresholds are speech platform specific and should be | |
| | configurable. This method is used when at least two commands of the | |
| | current dialog require different confidence or two different confirmation sub- | |
| | dialogs are used. Normally, more destructive (delete message) or disconnect | |
| | (“hang-up”) commands require higher confidence compared to other | |
| | commands within the same menu/grammar. The command level confidence | |
| | setting overwrites one at the dialog level | |
| | speech-rejection-level Defines the level of speech recognition result | |
| | rejection level for a given command. Normally this property is used if the | |
| | dialog contains several commands that require different rejection levels. The | |
| | default value of this property is platform/speech engine specific, normally is | |
| | within 30%-40% range. The command level rejection setting overwrites one | |
| | at the dialog level | |
| | digit-confidence In digits only mode or when digits are entered in speech | |
| | mode, the confirmation dialog is entered if the number of digits entered is | |
| | greater or equal to digit-confidence property value | |
| | nomatch-reason This property is defined for nomatch outcome only. It | |
| | allows to play different audio and/or transition to different dialogs depending | |
| | on the reason for nomatch: | |
| | confirmation user did not confirm recognized result | |
| | recognition user input was not recognized | |
| | application outcome nomatch was generated by the application | |
| | business logic | |
| | confirm This property contains the name of the confirmation dialog which is | |
| | called based on digit or speech confidence conditions described above. If the | |
| | confirmation dialog returns outcome “nomatch”, then the final “nomatch” | |
| | dialog outcome is set and the corresponding “nomatch” action is executed. | |
| | In case of “match” outcome from the confirmation dialog, the final “match” | |
| | outcome is assumed and the corresponding command action is executed in | |
| | the parent dialog | |
| | inherit Should be used mostly when it is necessary to disable <actions> | |
| | inheritance while otherwise using dialog level inheritance. By default, | |
| | <actions> inheritance is enabled; inherit = “true” is assumed. <actions> are | |
| | inherited together with its child <input> (grammars). It is not possible to | |
| | disable <input> (grammar) inheritance while enabling its corresponding | |
| | <actions> inheritance. <input> (grammar) of the inherited dialog is always | |
| | merged with the <input> (grammar) of the dialog that declared the | |
| | inheritance | |
| | Notes: | |
| | 3) | “speech-confidence-threshold”, “digit-confidence”, “confirm” properties set at |
| | | the actions command level [symbol] overwrite the same properties set at the dialog |
| | | level. |
| | 4) | If <action> does not contain any transitional element (goto or return), |
| | | return=“_self” is assumed by default. There is an infinite loop protection in |
| | | wsdml interpreter, so eventually (after many iterations) any dialog looping to |
| | | _self will cause the application to quit. |

| | | |
|---|---|---|
| Usage | Parents | Children |
| | <dialog> | <audio> <if> <goto> |
| | | <goto-application> <return> |

| | |
|---|---|
| Example | <actions> |
| | <action outcome=”nomatch” return=”_self” /> |
| | <action outcome=”nomatch” return=”_self” nomatch-reason=”confirmation”> |
| | <audio src=”Sorry about that” /> |
| | <action> |
| | <action outcome=”noinput” goto=”Goodbye” /> |
| | <action command=”cancel” return=”_prev” /> |
| | <audio name=”CommonUC.vc_cancelled”/> |
| | </action> |
| | <action command=”goodbye” speech-confidence-threshold=”high” |
| | confirm=”ConfirmGoodbye” > |
| | <if var=”IsSubscriber” > |
| | <audio name=”CommonUC.vc_goodbye” /> |
| | </if> |
| | goto target=”_quit” |
| | </action> |
| | <action command=”listen_to_messages” goto=”ListenToMessages” /> |
| | <action command=”make_a_call” goto=”MakeACall” /> |
| | <action command=”call_contact” goto=”CallContact”/> |
| | <action command=”call_contact_name” goto=”CallContactName”/> |
| | <action command=”call_contact_name_at” goto=”CallContactNameAt”/> |
| | <action command=”check_horoscope” goto-application=”horoscope” |
| | goto=”CheckWhatElse” /> |
| | <action command=”check_weather” > |
| | <audio name=”CommonUC.vc_local_weather”/> |
| | <goto-application target=”weather” /> |
| | <goto target=”CheckWhatElse” /> |
| | </action> |
| | </actions> |

<applications> <application>

| | |
|---|---|
| Syntax | <wsdml > |
| | <applications> |
| | <application |
| | name=”string” |
| | start = “string” |
| | language = “en-US \| en \| fr \| fr-CA\| es \|...” |
| | voice-personality = “string” |
| | voice-gender=”Male \| Female” |
| | /> |
| | </applications> |
| | </wsdml> |
| Description | The <application> element may include the following properties: |
| | start defines the starting dialog name for a given application |
| | language (optional) defines the run-time audio prompt, TTS, ASR and |
| | textual content language for a given application |
| | voice-personality (optional) defines the personality of the audio prompts, |
| | e.g. “Kate”. Personality may or may not be associated with a particular |
| | language |
| | voice-gender (optional) defines the gender of the recoded voice and by |
| | association the gender of generated voice via TTS |
| Usage | Parents Children |
| | <wsdml> None |
| Example | <wsdml> |
| | <applications> |
| | <application name=”IvyStoreLocator” start=”IvyStart” language=”en-US” voice- |
| | personality=”Kate” voice-gender=”Female” /> |
| | <application name=”AcmeLocator” start=”AcmeStart” language=”en-US” voice- |
| | personality=”Kate” voice-gender=”Female” /> |
| | </applications> |
| | <dialogs group=”StoreLocatorApplications”> |
| | <dialog name=”IvyStart” flush-digits=”true” inherit=”PurePlayTemplate”> |
| | <prompts> |
| | <prompt outcome=”init”> |
| | <audio name=”StoreLocator.lc_welcome_ivy” /> |
| | </prompt> |
| | </prompts> |
| | <actions> |
| | <action outcome=”all” goto=”StoreLocatorGreetings” /> |
| | </actions> |
| | </dialog> |
| | <dialog name=”NikeStart” inherit=”PurePlayTemplate”> |
| | <prompts> |
| | <prompt outcome=”init”> |
| | <audio name=”StoreLocator.lc_welcome_acme” /> |
| | </prompt> |
| | </prompts> |
| | <actions> |
| | <action outcome=”all” goto=”StoreLocatorGreetings” /> |
| | </actions> |
| | </dialog> |
| | </dialogs> |
| | </wsdml> |

<audio>

| Syntax | <audio | |
|---|---|---|
| | name = “string” | |
| | src = “string” | |
| | text = “string” | |
| | var = “string” | |
| | comment = “string” | |
| | Child_elements | |
| | </audio> | |
| Description | Specifies audio properties, such as name, the optional file source, src, and the | |
| | textual content, text. If a file source is not specified, it is looked up in the | |
| | <audiolist>, then if not found there, the text is synthesized via the TTS | |
| | engine. If the audio source can only be determined during run-time, var | |
| | property is used to pass a variable audio component name content. See | |
| | <var> section for more info. To make dialog flow more transparent, | |
| | comment property can be used to describe the audio content in cases | |
| | where it is set through <var> during runtime. | |
| | Child element <slots> can only be used inside <audio> in the <test-case> context. | |
| | In that case, it contains slot names and their values that must be observed | |
| | during automated testing using their container <test-case>. | |
| Usage | Parents | Children |
| | <prompt> <action> <audiolist> | <slots> |
| | <test-case> | |

| | |
|---|---|
| Example | <audiolist language=”en-US” format=”pcm” rate=”8” > |
| | <audio name=”CommonUC.another_party” src=”vc_another_party” |
| | text=”Would you like to call another party?” /> |
| | ... |
| | </audiolist> |
| | ... |
| | <dialog name=”DialOutcome” inherit=”PurePlayDialogTemplate” |
| | flush-dtmf=”true”> |
| | <vars> |
| | <var type=”audio” name=”DialOutcome” /> |
| | </vars> |
| | <prompts> |
| | <prompt outcome=”init” > |
| | <audio var=”DialOutcome”> comment=”Busy, no answer, call |
| | waiting or nothing is played here depending on the call completion status” /> |
| | <audio name = “CommonUC.another_party” /> |
| | </prompt> |
| | </prompts> |
| | </dialog> |
| | <test-cases> |
| | <test-case name=”test1”> |
| | <slots> |
| | <slot name=”category” value=”help” /> |
| | </slots> |
| | <audio name=”HelpCommand” /> |
| | <audiolist name=”CallCommands” > |
| | <slots> |
| | <slot name=”category” value=”call” /> |
| | </slots> |
| | </audiolist> |
| | </test-case> |
| | </test-cases> |

<audiolist>

| Syntax | <audiolist | |
|---|---|---|
| | name = “string” | |
| | language = “en-US \| en \| fr \| fr-CA\| es\|... ” | |
| | format = “pcm \| adpcm \| gsm \| mp3...” | |
| | rate = “6 \| 8” | |
| | src-base = “string” | |
| | default-extension = “.pcm \| .mp3 \| .vox \| .wav ” | |
| | Child_elements | |
| | </audiolist> | |
| Description | <audiolist> element is used in two contexts: 1) as a container of pre-recorded audio | |
| | files and their common properties and 2) as a test-case reference to the | |
| | corresponding <audiolist> container to enable automated speech recognition | |
| | testing | |
| | <audiolist> properties: | |
| | Name: usually identifies if the list belongs to an application or is a general | |
| | purpose list | |
| | Language: ISO 639-1, ISO 639-2 standard language codes are used | |
| | Audio format: one of pcm, adpcm, gsm, mp3, etc. | |
| | Sampling rate: 8 KHz (default) | |
| | Default extension assumed for audio files without an extension, e.g., “.pcm”; | |
| | period must be used as the first character | |
| | The absolute path to an audio file in the development or run-time | |
| | environment which, must have identical directory structure, is comprised of: | |
| | $ROOT/[src_base/][language/][persona/][src] | |
| | $ROOT is root directory normally defined in the environment where | |
| | wsdml | |
| | application content is located | |
| | language and persona are optional and are set by the application | |
| | during | |
| | run-time | |
| | src is the name of the audio file as defined in <audio /> | |
| | Child element <slots> can only be used inside <audiolist> in the <test-case> context. | |
| | In that case, it contains slot names and their values that must be observed | |
| | during automated testing using their container <test-case>. | |
| | An application can have several audio lists defined, such as Standard for days, | |
| | numbers, dates, money etc., CommonUC for prompts common to all UC | |
| | applications, VirtualPBXApp prompts only found in virtual PBX, corporate | |
| | applications, ConferencingApp conferencing only prompts, FaxApp fax only | |
| | prompts, etc | |
| Usage | Parents | Children |
| | <wsdml>, <test-case> | <audio>, <slots> |

| | |
|---|---|
| Example | <audiolist name=”CommonUC” format=”pcm” rate=”8” language=”en-US” |

default-extension =
“.pcm >

```
        <audio name=”vc_sorry_about_that”
              src=”vc_sorry_about_that” text=”Sorry about that.”
        />
        <audio name=”vc_cancelled” src=”vc_cancelled”
              text=”Cancelled.”
        />
        <audio name=”vc_is_this_ok” src=”vc_is_this_ok”
              text=”Is this okay?”
        />
        <audio name=”vc_press1_or_2” src=”vc_press1_or_2”
              text=”Press one if correct or two if incorrect?”
        />
        <audio name=”vc_didnt_understand” src=”vc_didnt_understand”
              text=”I am sorry, I didn't understand you” />
</audiolist>
<test-cases>
    <test-case name=”commands”>
      <slots>
        <slot name=”category” value=”help” />
        </slots>
        <audio name=”HelpCommand” />
        <audiolist name=”BillingCommands” >
          <slots>
            <slot name=”category” value=”billing” />
          </slots>
        </audiolist>
    </test-case>
</test-cases>
```

<commands>, <command>

| | | |
|---|---|---|
| Syntax | <command | |
| | | name = “string” |
| | | code = “string” |
| | | dtmf = ”string” |
| | | dtmf-format = ”string” |
| | | dtmf-slot = ”string” |
| | | Child_elements |
| | /> | |

| Description | Element <command> defines dtmf and symbolic command | |
|---|---|---|
| | map for a given <input> element. It also may define a | |
| | named slot via property dtmf-slot where WSDML runtime | |
| | should place digits entered by the caller via the phone | |
| | keypad. The optional property code describes the numeric | |
| | value returned from the grammar to the application if any. | |
| | Normally, grammars should return symbolic command | |
| | value upon speech or dtmf input. If a spoken command | |
| | does not have a dtmf equivalent, the latter can be omitted. | |
| | dtmf-format property refers to a corresponding | |
| | <dtmf-format> element which contains a regular expression | |
| | describing the format of variable-length dtmf user entry. | |
| | The WSDML runtime interpreter will always first try to | |
| | match the explicitly defined dtmf, then if no match, will | |
| | try to match against the dtmf-format | |
| Usage | Parents | Children |
| | <input> | <test-cases>, <test-case> |

| | |
|---|---|
| Example | <input name=”MainMenu” grammar-source=”.MENU”> |
| | <slots> |
| | <slot name=”menu” type=”command” /> |
| | <slot name=”data” /> |
| | </slots> |
| | <commands> |
| | <command name=”dial” dtmf=”25” /> |
| | <command name=”dial_number” dtmf-slot=”data” |

dtmf-format=”7_10_or_11_digits” />

```
      <command name=”goodbye” dtmf=”99”>
    </command>
  </commands>
</input>
...
```

<dialogs>, <dialog>

| | |
|---|---|
| Syntax | <dialog |
| | name=”string” |
| | template=”true \| false” |
| | inherit=”string” |
| | input=”string” |
| | noinput-command=”string” |
| | noinput-timeout=”string” |
| | inter-digit-timeout=”string” |
| | flush-digits=”true \| false” |
| | term-digits=”string” |
| | detect-digit-edge=”string” |
| | etect-speech=”true \| false” |
| | detect-digits=”true \| false” |
| | detect-fax=”true \| false” |
| | noinput-count=”integer” |
| | nomatch-count=”integer” |
| | error-count=”integer” |
| | digit-confidence=”integer” |
| | speech-end-timeout=”string” |
| | speech-barge-in=”true \| false” |
| | speech-max-timeout=”string” |
| | speech-confidence-threshold=”low \| medium \| high \| integer” |
| | speech-rejection-level=”low \| medium \| high \| integer” |
| | play-max-time=”string” |
| | play-max-digits=”integer” |
| | play-speed=”string” |
| | play-volume=”string” |
| | record-beep=”true \| false” |
| | record-max-silence=”string” |
| | record-max-no-silence=”string” |
| | record-max-time=”string” |
| | record-m ax-digits=”integer” |
| | collect-max-digits=”integer” |
| | collect-max-time=”string” |
| | Child_elements |
| | </dialog> |
| Description | Describes important properties and elements of speech dialog as it is defined above |
| | (see WSDML Dialog Concept). The dialog properties are not persistent and are reset |
| | automatically to their defaults upon any dialog entry and require explicit setting within |
| | the dialog whenever different property values are required. |
| | name* Name of the dialog |
| | template* If “true”, defines the dialog as a template dialog only designed for |
| | other dialogs to inherit from. All dialog properties and child elements can be |
| | inherited. Normally, only typical dialog properties, prompts and actions are |
| | inherited. |
| | inherit* Defines a dialog template name to inherit the current dialog |
| | properties and child elements <prompts>, <actions>, <vars> and <events>. |
| | <vars> and <events> are inherited the same way as dialog |
| | properties: by simply merging vars/events in the child dialog with the |
| | ones from parent(s). Elements with the same name (the same value |
| | of the “name” property) in the child have precedence over ones in |
| | parent(s). Prompt inheritance works in the following way: if the child |
| | dialog has no matching prompts for the current context, then prompts |
| | are looked up in its parent then parent's parent, and so on. If at least |
| | one prompt is found, no further lookup in parent is performed. Action |
| | inheritance works in the following way: a lookup is performed first in |
| | child and then in parent(s). Here's the action lookup order: |

by command in child
by command in parent(s)
by outcome in child
by outcome in parent(s)
default in child
default in parents

| | input Refers to the name of the user input descriptor which is required in | |
|---|---|---|
| | the dialog to process user's input (see input tag). The presence of the input | |
| | property in the dialog properties is required for PlayListen or Listen execution | |
| | when caller input is expected. If the input property is absent, simple Play will | |
| | be executed and no input will be expected within the dialog | |
| | term-digits A string of telephone keypad characters. When one of them is | |
| | pressed by the caller, collectdigits function terminates. Normally not used in | |
| | play or record function. | |
| | flush-digits* If “true”, flush any digits remaining in the buffer, before playing | |
| | the initial dialog prompt (default is “false”) | |
| | detect-digit-edge Sets dtmf/mf trailing or leading edge to trigger digit | |
| | detection | |
| | detect-speech* If “true”, enables speech detection (default is “true”) | |
| | detect-digits* If “true”, enables digits detection (default is “true”) | |
| | detect-fax* If “true”, enables fax tone detection (default is “false”) | |
| | noinput-timeout Maximum time allowed for the user input (speech or | |
| | digits) in seconds (s) or milliseconds (ms) after the end of the corresponding | |
| | prompt | |
| | inter-digit-timeout Maximum time allowed for the user to enter more digits | |
| | once at least one digit was entered; in seconds (s) or milliseconds (ms) | |
| | noinput-command Some dialogs, designed as list iterators, require | |
| | noinput outcome to be treated as one of the commands, e.g., “next”. This | |
| | property allows action for noinput behave as if a given command was issued | |
| | by the user | |
| | noinput-count Maximum number of iterations within the current dialog | |
| | while no user input is received. Once the number of noinput dialog iterations | |
| | reaches noinput-count, outcome noinput is generated upon dialog exit | |
| | nomatch-count Maximum number of iterations within the current dialog | |
| | while invalid, unexpected or unconfirmed user input is received. Once the | |
| | number of nomatch dialog iterations reaches nomatch-count, outcome | |
| | nomatch is generated upon dialog exit | |
| | error-count Maximum number of iterations within the current dialog while | |
| | either invalid, unexpected or unconfirmed input or no input is received; error- | |
| | count is incremented if either noinput-count or nomatch-count is | |
| | incremented. The final outcome upon dialog exit is the last outcome | |
| | occurred. So if error-count = “3” and the inputs collected were nomatch, | |
| | nomatch, noinput, the final outcome will be “noinput”. Once the number of | |
| | nomatch or noinput dialog iterations reaches error-count, the last iteration | |
| | outcome is generated upon dialog exit | |
| | digit-confidence Minimum number of digits the caller must enter within the | |
| | parent dialog before the confirmation sub-dialog is entered. The default value | |
| | is 0, which effectively disables confirmation of touch-tone entries. Normally, | |
| | this property is used when long digit sequences (e.g. phone, credit card | |
| | numbers) must be confirmed | |
| | speech-end-timeout* Maximum time in seconds (s) or milliseconds (ms) of | |
| | silence after some initial user speech before the end of speech is detected | |
| | (default is 750 ms). Note: if speech detection is enabled, speech parameters | |
| | overwrite potentially conflicting digits parameters, e.g. speech-max-timeout | |
| | is higher priority then collect-max-time | |
| | speech-barge-in* If “true”, allows the user to interrupt a prompt with a | |
| | speech utterance (default is “true”) | |
| | speech-max-timeout* Maximum duration in seconds (s) or milliseconds | |
| | (ms) of continuous speech by the user or speech-like background noise | |
| | speech-confidence-threshold Defines the level (always, low, medium or | |
| | high) of speech recognition result confidence, below which a confirmation | |
| | sub-dialog is entered, if it is defined in the parent dialog. The value of this | |
| | property is platform/speech engine specific, but normally is within 40%-60% | |
| | range | |
| | speech-rejection-level Defines the level of speech recognition result | |
| | rejection level for a given dialog. The default value of this property is | |
| | platform/speech engine specific, normally is within 30%-40% range. | |
| | digit-barge-in* If “true”, allows the user to interrupt a prompt with a digit, | |
| | otherwise if “false” the prompt will be played to the end ignoring dtmfs | |
| | entered by the user (default is “true”) | |
| | collect-max-digits Maximum number of digits before termination of collect- | |
| | digits function. The default is 1. | |
| | record-max-time Maximum time allowed in seconds before termination of | |
| | record function (default is platform specific). Normally, this property requires | |
| | attention when (conference) call recording type feature requires longer then | |
| | normal record time. | |
| | play-speed Speed of audio playback (mostly used in voicemail): low, | |
| | medium, high (default is medium) | |
| | play-volume Volume of audio playback: low, medium, high (default is | |
| | medium) | |
| | record-max-silence Silence time in seconds (s) or milliseconds (ms) | |
| | before recording terminates (default is 7 s) | |
| | record-max-no-silence Non-silence time in seconds (s) or milliseconds | |
| | (ms) before recording terminates (default is 120 s) | |
| | record-beep If “true”, play a recognizable tone to signal the caller that | |
| | recording is about to begin (default is “true”) | |
| | Note: caller speech recording is enabled through input property referencing an | |
| | <input> element containing record = “true” property. Normally, a dialog with speech | |
| | recording function would inherit a standard template containing a input component | |
| | with such record = “true” property | |
| Usage | Parents | Children |
| | <wsdml>, <dialogs> | <prompts>, <actions>, <vars> <events> |

| | |
|---|---|
| Example | <?xml version=”1.0” encoding=”utf-8” ?> |
| | <wsdml> |
| | <applications> |
| | <application=”mcall” start=”StartDialog” /> |
| | </applications> |
| | ... |
| | <audiolist> |
| | ... |
| | </audiolist> |
| | <dialogs> |
| | <dialog name=”PlayListenDialogTemplate” template=”true” |
| | speech-timeout=”0.75” |
| | speech-barge-in=”true” |
| | speech-max-timeout=”5” |
| | noinput-timeout=”5” |
| | inter-digit-timeout=”5” |
| | flush-digits=”false” |
| | term-digits=”” |
| | detect-speech=”true” |
| | detect-digits=”true” |
| | detect-fax=”false” |
| | noinput-count=”2” |
| | nomatch-count=”2” |
| | > |
| | </dialog> |
| | <dialog name=”AddParty” inherit=”PlayListenDialogTemplate” |
| | nomatch-count=”3” speech-max-timeout=”20” |
| | speech-end-timeout=”1.5” collect-max-digits=”10” |
| | term-digits=”#” speech-confidence-threshold=”low” |
| | digit-confidence=7 input=”PhoneAndName” > |
| | <vars> |
| | <var type=”audio” name=”Invalid_name_or_number” /> |
| | <var type=”text” name=”NameOrNumber” /> |
| | </vars> |
| | <events> |
| | <event name=”CallWaiting” goto=”CallWaitingDialog” /> |
| | <event name=”MsgWaiting” goto=”MsgWaitingDialog” /> |
| | </events> |
| | <prompts> |
| | <prompt outcome=”init” > |
| | <audio name=”CommonUC.vc_name_or_number” /> |
| | </prompt> |
| | <prompt outcome=”noinput” mode=”speech”> |
| | <audio name=”CommonUC.havent_heard_you”/> |
| | <audio name=”CommonUC.vc_say_phone_or_name” |
| | /> |
| | </prompt> |
| | <prompt outcome=“noinput “ mode=“dtmf “ > |
| | <audio name=”CommonUC.havent_heard_you “ /> |
| | <audio name=”CommonUC.vc_phone_few_letters”/> |
| | </prompt> |
| | <prompt outcome=”nomatch” mode=”speech” input-type=”speech”> |
| | <audio name=”CommonUC.vc_didnt_understand”/> |
| | <audio name=”CommonUC.vc_say_phone_or_name” /> |
| | </prompt> |
| | <prompt outcome=”nomatch” mode=”speech” input-type=”dtmf”> |
| | <audio var=”Invalid_name_or_number” /> |
| | <audio name=”CommonUC.vc_say_phone_or_name” |
| | /> |
| | </prompt> |
| | <prompt outcome=”nomatch” mode=”dtmf”> |
| | <audio var=”Invalid_name_or_number” /> |
| | <audio name=”CommonUC.vc_phone_or_few_letters” |
| | /> |
| | </prompt> |
| | </prompts> |
| | <actions> |
| | <action outcome=”noinput” return=”_prev”/> |
| | <action outcome=”nomatch” return=”_self” /> |
| | <action outcome=”nomatch” return=”_prev” /> |
| | <action command=”help” return=”_self”> |
| | <audio name=”CommonUC.vc_add_party_help” |
| | </audio> |
| | </action> |
| | <action command=”cancel” confirm=”ConfirmCancel” |
| | speech-confidence-threshold=”low” return=”_prev”> |
| | <audio name=”CommonUC.vc_cancelled” /> |
| | </action> |
| | <action outcome=”match” goto=”DialingNumber” > |
| | </actions> |
| | </dialog> |
| | </dialogs> |
| | </wsdml>. |

<dtmf-formats>, <dtmf-format>

| Syntax | <dtmf-format | |
|---|---|---|
| | name = “7_to_10_digits ” | |
| | format = “string” | |
| | </> | |
| Description | The value of the “format” attribute is currently defined | |
| | as a perl regular expression that has to match the entire | |
| | user input (with “ [symbol] ” at the beginning and | |
| | “$” at the end implied). If it has a capture group | |
| | (part in parenthesis), then only the matching part will be | |
| | used as a user input. The example below matches 7 to | |
| | 10 digits optionally followed by # with # | |
| | removed from the user input. This element is referenced | |
| | by the dtmf-format property of <command> element | |
| Usage | Parents | Children |
| | <wsdml> | none |

| | |
|---|---|
| Example | <dtmf-formats> |
| | <dtmf-format name=”7_to_10_digits” |
| | format=” ( \d { 7,10 } ) #?” /> |
| | </dtmf-formats> |

<event>, <events>

| Syntax | <events inherit=”false \| true” | |
|---|---|---|
| | <event | |
| | name = “CallWaiting ” | |
| | goto = “string” | |
| | </> | |
| | </events> | |
| Description | Defines named events and corresponding dialog transitions via goto property from a | |
| | given dialog. <events> property inherit should be used mostly when it is necessary to | |
| | disable event inheritance while otherwise using dialog level inheritance. By default, | |
| | <events> inheritance is enabled; inherit=“true” is assumed. Events will be only | |
| | handled by the WSDML framework during the execution of those dialogs where they | |
| | are defined. Events that are relevant in WSDML context include those that require | |
| | caller detectable dialogs, e.g., CallWaiting and MessageWaiting. Events that do not | |
| | require caller detectable actions, e.g. caller hang-up event, do not have to be | |
| | described as part of <events> element. Return from an event handling dialog works | |
| | exactly the same way as return from any other dialog. | |
| Usage | Parents | Children |
| | <dialog> | none |

| | |
|---|---|
| Example | <events inherit=”false”> |
| | <event name=”CallWaiting” goto=”CallWaitingDialog” /> |
| | <event name=”MessageWaiting” goto=”MessageWaitingDialog” /> |
| | </events> |

<if> <elseif><else>

| Syntax | <if cond = “string”> | |
|---|---|---|
| | Child_elements | |
| | <elseif cond = “string”/> | |
| | Child_elements | |
| | <else/> | |
| | Child_elements | |
| | </if> | |
| | cond = “var \| slot” | |
| Description | Currently, cond includes var or slot element. To simplify the cond evaluator, only “=” | |
| | operator is defined. When cond attribute evaluates to true, then the audio part or goto | |
| | transition between the <if> and the next <elseif>, <else>, or </if> is processed. No | |
| | nested <if> are allowed in wsdml. Complex conditions shall be handled by business | |
| | logic software and/or grammar interpreters normally supplied as part of core speech | |
| | engines. | |
| Usage | Parents | Children |
| | <action> <prompt> | <audio> <goto> |

| | |
|---|---|
| Example | <vars> |
| | <var type=”boolean” name=”FollowMe” /> |
| | </vars> |
| | ... |
| | <prompt outcome=”noinput” count=”1”> |
| | <if var=”FollowMe” > |
| | <audio src=”menu1.pcm” |
| | text=”Say, listen to messages, make a call, transfer my |
| | calls, stop following me, send message, check my |
| | email, check my faxes, set my personal options, |
| | access saved messages or restore deleted |
| | messages.” |
| | /> |
| | <else /> |
| | <audio src=”menu2.pcm” |
| | text=”Say, listen to messages, make a call, transfer my |
| | calls, start following me, send message, check my |
| | email, check my faxes, set my personal options, |
| | access saved messages or restore deleted |
| | messages.” |
| | /> |
| | </if> |
| | </prompt> |
| | ... |
| | ... |
| | <action command=”call_contact” > |
| | <if slot=”param2” > |
| | <goto target=”CallContactNameAt” /> |
| | <elseif slot=”param1” /> |
| | <goto target=”CallContactName” /> |
| | <else /> |
| | <goto target=”CallContact” /> |
| | </if> |
| | </action> |

<inputs>, <input>

| Syntax | <input> | |
|---|---|---|
| | name = “string” | |
| | grammar-source = “string” | |
| | record = “true \| false” | |
| | Child_elements | |
| | </input> | |
| Description | <input> element is used to describe expected user input, i.e. speech, dtmf in regular | |
| | wsdml applications as well as in separate test-case wsdml descriptors for automated | |
| | testing of speech applications. In the latter case, it is used in an abbreviated form, | |
| | e.g., without grammar references. The separation of test case descriptors from the | |
| | main body of WSDML is recommended: a) to improve WSDML runtime | |
| | performance and b) to allow auto-generation of test cases from application | |
| | logs. | |
| | Both precompiled and inline (JIT—just in time) grammars are supported in wsdml | |
| | framework. Static or dynamic grammars for the entire application are kept in separate | |
| | precompiled files that can be referenced by name or URL. <input> element specifies | |
| | the following properties: | |
| | name as an internal wsdml reference and grammar-source as a reference | |
| | to the actual pre-compiled grammar static or dynamic | |
| | grammar-source can contain an external grammar identifier, e.g., “.MENU” | |
| | from the compiled static grammar package or URL to a dynamic grammar. | |
| | Child element <grammar-source> is also supported. <grammar-source> | |
| | element and <grammar-source> property are mutually exclusive. The | |
| | purpose of <grammar-source> element is to enable JIT grammar inclusion. | |
| | A JIT grammar can be in any standard grammar format, such as grXML or | |
| | GSL. Any existing JIT grammar can be inserted into <grammar-source /> | |
| | without any modifications | |
| | record this property is set to “true” when the caller speech must be recorded | |
| | in the dialog referencing the corresponding input element; normally, speech | |
| | recording is supported as a single function, the ability to record speech | |
| | simultaneously with other functions, such as speech recognition or caller | |
| | voice verification is platform dependent | |
| | Child element <slots> describes slots that are requested by the application and | |
| | returned by the speech recognizer filled or unfilled based on the user utterance; | |
| | <commands> describes the list of commands and their corresponding dtmf and | |
| | optional return codes. Commands are used to consolidate different types of speech | |
| | and dtmf input and transfer control to specific dialogs. Dialog inheritance results in | |
| | merge of all <inputs> of the inherited hierarchy of dialogs with the target dialog | |
| | <inputs>. The only way to prevent merging of inherited <inputs> while otherwise | |
| | keeping other dialog content inherited is by blocking inheritance at <actions> level. | |
| Usage | Parents | Children |
| | <wsdml>, <inputs> | <grammar-source>, <slots>, |
| | | <commands> |

| | |
|---|---|
| Example | <inputs> |
| | <input name=”Recording” record=”true” /> |
| | <input name=”MainMenu” grammar-source=”.MENU”> |
| | <slots> |
| | <slot name=”command” type=”command”/> |
| | <slot name=”data” /> |
| | </slots> |
| | <commands> |
| | <command name=”check_voicemail” code=”10” dtmf=”10” /> |
| | <command name=”dial_number” code=”25” dtmf-format=”7_or_10_digits” /> |
| | </commands> |
| | </input> |
| | <input name=”YesNoRepeat” > |
| | <grammar-source type=”grxml” > |
| | <grammar |
| | xmlns=”http://www.w3.org/2001/06/grammar” |
| | xmlns:nuance=”http://voicexml.nuance.com/grammar” |
| | xml:lang=”en-US” |
| | version=”1.0” |
| | root=”YesNoRepeat” |
| | mode=”voice” |
| | tag-format=”Nuance”> |
| | <rule id=”YesNoRepeat” scope=”public”> |
| | <one-of lang-list=”en-US”> |
| | <item> yes <tag> <![CDATA[ <menu “1”> ]]> </tag> </item> |
| | <item> no <tag> <![CDATA[ <menu “2”> ]]> </tag> </item> |
| | <item> |
| | <ruleref uri=”#START_REPEAT_DONE”/> <tag><![CDATA[ |
| | <menu $return>]]> </tag> |
| | </item> |
| | </one-of> |
| | </rule> |
| | <rule id=”START_REPEAT_DONE” scope=”public”> |
| | <one-of> |
| | <item> repeat |
| | <tag> return (“4”) </tag> |
| | </item> |
| | <item> start over |
| | <tag> return (“7”) </tag> |
| | </item> |
| | <item> i am done |
| | <tag> return (“9”) </tag> |
| | </item> |
| | </one-of> |
| | </rule> |
| | </grammar> |
| | </grammar-source> |
| | </input> |
| | </inputs> |

<prompts>, <prompt>

| Syntax | <prompts inherit = “false \| true”> | |
|---|---|---|
| | <prompt | |
| | outcome = “init \| noinput \| nomatch” | |
| | count = “string” | |
| | min-count = “string” | |
| | max-count = “string” | |
| | mode = “speech \| digits” | |
| | input-type = “speech \| digits” | |
| | ... | |
| | Child_elements | |
| | </prompt> | |
| | </prompts> | |
| Description | Defines prompt properties and audio elements it is comprised of. | |
| | outcome specifies the state of a regular dialog or confirmation dialog when | |
| | a given prompt must be played | |
| | init outcome is set upon the entry into the dialog | |
| | noinput outcome occurs when some user input was expected but | |
| | was not received during a specified time period | |
| | nomatch outcome occurs when some unexpected or invalid user | |
| | input was received in the form of spoken utterance or touch-tone | |
| | command; match outcome is only used at the actions level | |
| | count specifies the current dialog iteration count when a given prompt must | |
| | be played. Maximum number of iterations for both noinput, and nomatch | |
| | outcomes is normally defined as dialog template properties which are | |
| | inherited by similar behaving dialogs. String ‘last’ is also defined for this | |
| | property which helps when it is necessary to play certain prompts upon | |
| | completing the last dialog iteration | |
| | min-count, max-count these optional properties used to specify a range of | |
| | counts; max-count = “5” is true on dialog counts = <5, min-count = “3” is true | |
| | on dialog counts = >3; the same prompt can have both properties defined | |
| | mode specifies one of two dialog modes: speech or digits. The mode is | |
| | system selectable and is defined in WSDML to play relevant prompts | |
| | suggesting dtmf entry. Unless, For example, the system can set mode value | |
| | to “digits” if the dialog attribute “detect-speech” is set to false, if the | |
| | user speech input is not understood repeatedly or if a speech port | |
| | cannot be allocated (dtmf only implementation). The speech mode | |
| | allows user interaction via speech or digits and normally requires prompts | |
| | suggesting just the speech input, rarely overloading the user with optional | |
| | touch-tone info. WSDML framework will try to reset mode to speech | |
| | every time a new dialog is entered. If digits mode switch is caused by | |
| | the user spoken input misrecognition in a given dialog, speech | |
| | resource will not be deallocated automatically and will be used in the | |
| | next dialog. Speech resource deallocation can be forced by setting | |
| | attribute “detect-speech” to false | |
| | Input-type specifies the type of input by the user: speech or digits. The | |
| | dialog context may require playing a different prompt depending on what the | |
| | user input was irrespective of the current mode. E.g., if the initial prompt | |
| | requests a speech command, but the user entered a touch-tone command, | |
| | the next prompt within the same dialog might suggest a touch-tone command | |
| | inherit Should be used mostly when it is necessary to disable <prompts> | |
| | inheritance while otherwise using dialog level inheritance. By default, | |
| | <prompts> inheritance is enabled and inherit = “true” is assumed | |
| | Notes: | |
| | If a dialog contains prompts without defined outcome, they will match | |
| | any outcome and will be queued for playback in the order they are listed | |
| | along with prompts matching a given specific outcome | |
| | For a given outcome, if no prompts for specific dialog iterations are | |
| | defined, while the dialog noinput-count or nomatch-count properties are | |
| | set greater then 1, the prompt for the given outcome or without any | |
| | outcome defined will be repeated for every dialog iteration | |
| Usage | Parents | Children |
| | <dialog> | <audio> |

| | |
|---|---|
| Example | <prompts> |
| | <prompt outcome=”init”> |
| | <audio src=”what_number.pcm” text=” What number should I dial?” |
| | /> |
| | </prompt> |
| | <prompt outcome=”noinput” mode=”speech” count=”1”> |
| | <audio src=”havent_heard_you.pcm” text=”I haven't heard from you” |
| | /> |
| | <audio src=”say_number.pcm “ text=” Please, say or touch-tone the phone |
| | number including the area code.” /> |
| | </prompt> |
| | <prompt outcome=”noinput” mode=”digits” count=”1”> |
| | <audio src=”havent_heard_you.pcm “ text=”I haven't heard from you.” |
| | /> |
| | <audio src=”enter_number.pcm “ text=”Please, enter the phone number |
| | including the area code.” |
| | /> |
| | </prompt> |
| | <prompt outcome=”noinput” mode=”speech” count=”2”> |
| | <audio src=”are_you_there.pcm” text=”Are you still there?”/> |
| | <audio src=”say_number.pcm” text=”Please, say or touch-tone the_phone |
| | number including the area code.” /> |
| | </prompt> |
| | <prompt outcome=”noinput” mode=”digits” count=”2”> |
| | <audio src=”are_you_there.pcm” text=”Are you still there?”/> |
| | <audio src=”enter_number.pcm” text=”Please, enter the phone number |
| | including the area code. “ |
| | /> |
| | </prompt> |
| | <prompt outcome=”nomatch” mode=”speech” count=”1” input-type=”speech”> |
| | <audio src=”i_am_not_sure_what_you_said.pcm” |
| | text=”I am not sure what you said” /> |
| | </prompt> |
| | <prompt outcome=”nomatch” mode=”speech” count=”1” input-type=”digits”> |
| | <audio src=”number_not_valid.pcm” text=”Number is not valid”/> |
| | <audio src=”enter_ten_dgt_number.pcm” text=”Please, enter a ten-digit |
| | phone number starting with the area code.” |
| | /> |
| | </prompt> |
| | <prompt outcome=”nomatch” mode=”speech” count=”2”> |
| | <audio src=”sorry_didnt_hear.pcm” text=”Sorry, I didn't |
| | hear that number right.” |
| | /> |
| | <audio src=”say_number.pcm” text=”Please, say or touch-tone the_phone |
| | number including the area code or say cancel.” |
| | /> |
| | </prompt> |
| | </prompts> |

<overrides>, <override>

| Syntax | <override | |
|---|---|---|
| | brand = “string” | |
| | corporate-account = “string”> | |
| | <dialog name = “oldname” replace=”newname” /> | |
| | <audio name=”oldname” replace=”newname” /> | |
| | <command input=”foo” name=”foobar” | |
| | code=”old-code” dtmf=”new-dtmf”/> | |
| | </override> | |
| Description | <overrides> is an optional section defined as part of the root document. Depending on | |
| | brand and/or corporate account, <override> specifies a dialog, audio file or dtmf | |
| | command to replace compared to default. For a example, a particular service brand | |
| | offered to the user base that arrived from an old legacy voice platform, may require | |
| | support of the same old dtmf commands, so that the user migration could be | |
| | accomplished easier | |
| Usage | Parents | Children |
| | <wsdml> <overrides> | Override specific : <dialog>, |
| | | <command>, <audio> |

| | |
|---|---|
| Example | <overrides> |
| | <override brand=”CommuniKate”> |
| | <dialog name=”DialogDefault” replace=”DialogCustom” /> |
| | <audio name=”CommonUC.vp_no_interpret” |
| | replace=”CommonUC.vp_no_interpret_new/> |
| | <command input=”MainMenu” name=”wait_minute” |
| | code=”95” dtmf=”95” /> |
| | </override> |
| | <override corporate-account=”12000”> |
| | .... |
| | </override> |
| | </overrides> |

<slots>, <slot>

| Syntax | <slot | |
|---|---|---|
| | name = “string” | |
| | type = “string” | |
| | grammar-slot-name = “string” | |
| | </slot> | |
| Description | <slot> elements are used within the parent grammar element to specify the data | |
| | elements requested from the speech server by the application. These data elements | |
| | are filled from the user spoken utterance according to the grammar rules. The slot | |
| | serving as a command attribute is specified using type = “command” property. | |
| | Internally, dialog state machine will retain the last dialog speech result context | |
| | including the command value as well as parameter values. This enables command | |
| | and parameter based dialog transitions in <actions> section of <dialog>. | |
| | grammar-slot-name property is used in cases where a third party or legacy binary | |
| | grammar slot names need to be mapped to the existing or more appropriate slot | |
| | names. WSDML framework supports only name based slot retrieval from the | |
| | recognition result. Positional slot retrieval based on the slot order is not supported. | |
| Usage | Parents | Children |
| | <input>, <test-case> | none |

| | |
|---|---|
| Example | <input name=”Menu” grammar-source=”.MENU”> |
| | <slots> |
| | <slot name=”menu” type=”command” /> |
| | <slot name=”contact” /> |
| | <slot name=”destination” /> |
| | </slots> |
| | <commands> |
| | <command name=”listen_to_messages” code=”10” dtmf=”10” /> |
| | <command name=”Imake_a_call” code=”20” dtmf=”20” /> |
| | <command name=”call_contact” code=”24” dtmf=”24” /> |
| | </commands> |
| | </input> |
| | ... |
| | <actions> |
| | <action command=”listen_to_messages” goto=”ListenToMessages” /> |
| | <action command=”make_a_call” goto=”MakeACall” /> |
| | <action command=”call_contact” > |
| | <if slot=”destination” > |
| | <goto target=”CallContactNameAt” /> |
| | <elseif slot=”contact” /> |
| | <goto target=”CallContactName” /> |
| | <else /> |
| | <goto target=”CallContact” /> |
| | </if> |
| | </action> |
| | </actions> |

<test-case>, <test-cases>

| Syntax | <test-case | |
|---|---|---|
| | name = “string” | |
| | outcome=”nomatch \| match” | |
| | Child_elements | |
| | /> | |
| Description | <test-case> element defines a specific test case used by a test application simulating | |
| | real user. Such test application can be automatically generated by WSDML test | |
| | framework. It will traverse the target application dialog tree using different test cases | |
| | to simulate different types of users, such as male, female, accented speech, as well | |
| | as different type of user input, such as noise, silence, hands-free speech, speaker | |
| | phone, etc. The audio elements within a particular test case for a particular command | |
| | may contain multiple utterances reciting a given command in various ways to achieve | |
| | specific testing goals as outlined above. As the testing application navigates the | |
| | dialog tree, it will randomly (or based on a certain algorithm) select from a preset | |
| | number of command utterances, noise and silence samples under a given test case, | |
| | thus simulating the real user input. Property outcome = “nomatch” indicates that | |
| | the corresponding test case is negative and is intended for testing false | |
| | positive results. All commands contained in such a test case should be | |
| | rejected. | |
| Usage | Parents | Children |
| | <command> | <audio>, <audiolist>, <slots> |

| | |
|---|---|
| Example | <input name=”Categorizer” > |
| | <commands> |
| | <command name=”reason-for-call” > |
| | <test-cases> |
| | <test-case name=”CloseAccount”> |
| | <slots> |
| | <slot name=”category” value=”close_account” /> |
| | </slots> |
| | <audiolist name=”CloseAccountCommands” /> |
| | <audio text=”I'd like to close my account” /> |
| | <audio text=”Can I close my account please” /> |
| | </test-case> |
| | <test-case name=”NoMatch” outcome=”nomatch”> |
| | <audio name=”SpeechSamples.random_speech_us_english” /> |
| | <audio name=”SpeechSamples.3sec_white_noise” /> |
| | </test-case> |
| | </test-cases> |
| | </command> |
| | </commands> |
| | </input> |
| | ... |

<vars>, <var>

| Syntax | <vars inherit = “false \| true” | |
|---|---|---|
| | <var | |
| | name = “string” | |
| | type = “boolean \| audio \| text” | |
| | format = | “date \| time \| week_day \| relative_date_label \| number |
| | | ordinal_number \| natural_number \| phone_number \| |
| | | currency \| credit_card_number” |

| | /> | |
|---|---|---|
| | ... | |
| | </vars> | |
| Description | <var> element describes a variable which must be set by the dialog state machine | |
| | during run-time. | |
| | <var> type is defined as: | |
| | Boolean | used in <if>, <elseif> |
| | Audio | used in <audio> |
| | Text | used in <audio> while enforcing TTS; no attempt will be made to |

| find corresponding audio files recorded by a human | |
|---|---|
| <var> property format is defined only for variables of type = “audio”, and its value can | |
| be one of: | |
| date - example: “September 24^{th}” | |
| time - example: “12 55 pm” | |
| week_day - example: “Monday” | |
| relative_date_label - example: “yesterday” | |
| number - example: “4 5 6” | |
| ordinal_number - example: “66^{th}” | |
| natural_number - example: “five hundred and twenty three” | |
| phone_number - example: | “8_rising 4 7 <pause> 2_rising 2 7 |
| | <pause> 3 4 4 2_falling” |

| | currency - example: | |
|---|---|---|
| | credit_card_number - example: | |
| | “1234<pause>5678<pause>4321<pause>8765 | |
| | <var> element can be used when the dialog's audio content, either completely, or | |
| | partially, can only be determined during run-time. Another use of <var> is possible | |
| | within <actions> section as part of <if>, <elseif> evaluator, to define conditional dialog | |
| | control transfer. If the format property is undefined, the content of <var> within the | |
| | <audio> is first checked against the <audiolist> defined for the current application, | |
| | then, if not found, is treated as text to be converted to audio by the available TTS | |
| | engine. | |
| Usage | Parents | Children |
| | <wsdml> <dialog> | none |

| | |
|---|---|
| Example | <vars> |
| | <var type=”boolean” name=”FollowMe” /> |
| | <var type=”audio” name=”DialOutcome” /> |
| | </vars |
| | <prompts> |
| | <prompt outcome=”init” > |
| | <audio var=”DialOutcome” /> |
| | </prompt> |
| | </prompts> |
| | <actions> |
| | <action outcome=”all” goto=”DialAnotherNumber” /> |
| | </actions> |
| | ... |

<wsdml>

| Syntax | <wsdml | |
|---|---|---|
| | namespace = “string” | |
| | ... | |
| | Child_elements | |
| | </wsdml> | |
| Description | Declares wsdml document and is the root document element. The root wsdml | |
| | document includes child elements discussed in this specification, such as <audiolist>, | |
| | <dialogs>, <inputs>, etc., and may include properties: | |
| | namespace the value of this attribute followed by a dot will automatically be | |
| | added as a prefix to all names of <dialog>, <input>, <application>, <dtmf- | |
| | format>, and <audio>. It will not be added to the references to elements: | |
| | goto, goto-application, target, input, confirm if they already contain the | |
| | namespace separator. | |
| Usage | Parents | Children |
| | None | <applications>, <audiolist>, dialogs>, |
| | | <inputs>, <overrides>, <prompts>, |
| | | <dtmf-formats> |

| Example | <?xml version=”1.0” encoding=”utf-8” ?> | |
|---|---|---|
| | <wsdml namespace=”Namespace”> | |
| | ... | |
| | <dialog name=”Dialog” ... > // actually refers to “Namespace.Dialog” | |
| | ... | |
| | <dialog name=”OtherName.Foo” ... > | // refers to |
| | | // “Namespace.OtherName.Foo” |

| ... | |
|---|---|
| <audio name=”Audio” /> // refers to “Namespace.Audio” in some audiolist | |
| ... | |
| <audio name=”VOCAB.1” /> // refers to “VOCAB.1” | |
| <action ... goto=”Name”> // goes to “Namespace.Name” | |
| <action ... goto=”OtherName.GlobalName”> | // goes to |
| | // “OtherName.GlobalName” |

...
</wsdml>

What is claimed is:

1. A method for developing a speech application, comprising the following steps:
creating a speech user interface description devoid of business logic in the form of a machine readable markup language directly executable by a runtime environment based on business requirements; and
creating separately at least one business logic component for said speech user interface, said at least one business logic component being accessible by said runtime environment.

2. The method of claim 1 wherein said markup language is Web Speech Dialog Markup Language.

3. The method of claim 1 wherein said speech user interface description is created by utilizing a graphical user interface toolkit.

4. The method of claim 3 wherein said speech user interface description comprises dialogs, grammars, prompts, and transitions.

5. The method of claim 1 wherein said speech user interface description contains at least one placeholder, said placeholder corresponding to said at least one business logic component.

6. The method of claim 5 wherein said at least one placeholder triggers said runtime environment to execute said at least one business logic component during execution of said speech user interface description.

7. The method of claim 6 wherein said at least one business logic component receives at least one command from a user during execution of said at least one business logic component.

8. The method of claim 7 wherein said user command is selected from the group consisting of: speech command, touch-tone command, keyboard command, keypad command, mouse command, touchpad command, drag-and-drop command, and any other mechanical or electronic device capable of interpreting user intent.

9. The method of claim 1 further comprising the step of separately testing said speech user interface and said at least one business logic component for errors.

10. The method of claim 9 wherein said testing is automated, said testing utilizing two or more interpreter instances communicating with one another, wherein at least one instance plays the role of a caller and at least one instance plays the role of a server.

11. A system for developing a speech application comprising:
a runtime environment;
a speech user interface description devoid of business logic in the form of a machine readable markup language directly executable by said runtime environment based on business requirements; and
at least one business logic component for said speech user interface, said at least one business logic component being accessible by said runtime environment.

12. The system of claim 11 wherein said markup language is Web Speech Dialog Markup Language.

13. The system of claim 11 further comprising a toolkit, said toolkit configured to create said speech user interface description by utilizing a graphical user interface for said runtime environment.

14. The system of claim 13 wherein said speech user interface description comprises dialogs, grammars, prompts, and transitions.

15. The system of claim 11 wherein said speech user interface description contains at least one placeholder, said placeholder corresponding to said at least one business logic component.

16. The system of claim 15 wherein said at least one placeholder is configured to trigger said runtime environment to execute said at least one business logic component during execution of said speech user interface description.

17. The system of claim 16 wherein said at least one business logic component is configured to receive at least one command from a user during execution of said at least one business logic component.

18. The system of claim 17 wherein said user command is selected from the group consisting of: speech command, touch-tone command, keyboard command, keypad command, mouse command, touchpad command, drag-and-drop command, and any other mechanical or electronic device capable of interpreting user intent.

19. The system of claim 11 wherein said runtime environment is configured to separately test said speech user interface and said at least one business logic component for errors.

20. The system of claim 19 wherein said testing is automated, said testing comprising two or more interpreter instances communicating with one another, wherein at least one instance is configured to play the role of a caller and at least one instance is configured to play the role of a server.

21. A method for developing, testing and implementing a speech application, comprising the steps of:
utilizing a speech user interface dialog development toolkit to create a speech user interface description;
said toolkit creating said speech user interface description in the form of a machine readable markup language, wherein said markup language describes only said speech user interface and not any underlying business logic, said speech user interface description comprising dialogs, commands, prompts, and transitions;
developing said business logic separately from said speech user interface description, with the only interaction between development of said business logic and creation of said speech user interface being in the form of at least one placeholder to indicate where said business logic may be required to return information;
separately testing said speech user interface and said business logic and providing feedback, said feedback relating to said speech user interface being separate from said feedback relating to said business logic;
utilizing an interpreter to execute said markup language, said interpreter separately interacting with said business logic as required by said at least one placeholder.

22. A system for developing, testing and implementing a speech application comprising:
a computer containing storage mediums with computer code mechanisms, wherein the computer code mechanisms collectively comprise:
a speech user interface dialog development toolkit, said toolkit configured to create a machine readable markup language;
said machine readable markup language describing only said speech user interface and not any underlying business logic, said machine readable markup language comprising at least one placeholder;
at least one business logic component, said business logic component associated with said at least one placeholder of said machine readable markup language; and
an interpreter, said interpreter configured to execute said machine readable markup language, said interpreter further configured to separately interact with said business logic as required by said at least one placeholder.
